(19) United States
(12) Patent Application Publication
(10) Pub. No.: US 2025/0373367 A1
(43) Pub. Date: Dec. 4, 2025

(54) TRANSMISSION REPETITION ADAPTATION BASED ON SLOT TYPE

(71) Applicant: Qualcomm Incorporated, San Diego, CA (US)

(72) Inventors: Marwen ZORGUI, San Diego, CA (US); Ahmed Attia ABOTABL, San Diego, CA (US); Diana MAAMARI, San Diego, CA (US); Muhammad Sayed Khairy ABDELGHAFFAR, San Jose, CA (US)

(21) Appl. No.: 18/680,423

(22) Filed: May 31, 2024

(51) Int. Cl. H04L 1/08; H04L 5/14; H04W 72/0446

(52) U.S. Cl. CPC H04L 1/08; H04L 5/14; H04W 72/0446

(57) ABSTRACT

Certain aspects of the present disclosure provide techniques for transmission repetition adaptation based on slot type. A method generally includes receiving a configuration comprising: a first indication of a repetition factor indicating a minimum quantity of repetitions required for a transmission between a node and the apparatus; and a second indication of at least one duplexing factor indicating a repetition count associated with at least one of a full duplex (FD) slot or a sub-band full duplex (SBFD) slot; and determining available slot(s) for communicating repetition(s) of the transmission, wherein: the available slot(s) comprise at least one of the FD slot or the SBFD slot, and a number of the available slot(s) satisfy the repetition factor when using the at least one duplexing factor to count at least one of the repetition(s) of the transmission in at least one of the FD slot or the SBFD slot.

### INTRODUCTION

### Field of the Disclosure

Aspects of the present disclosure relate to wireless communications, and more particularly, to techniques for transmission repetition.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving a configuration comprising: a first indication of a repetition factor indicating a minimum quantity of repetitions required for a transmission between a node and the apparatus; and a second indication of at least one duplexing factor indicating a repetition count associated with at least one of a full duplex (FD) slot or a sub-band full duplex (SBFD) slot; determining one or more available slots for communicating one or more repetitions of the transmission, wherein: the one or more available slots comprise at least one of the FD slot or the SBFD slot; and a number of the one or more available slots satisfy the repetition factor when using the at least one duplexing factor to count at least one of the one or more repetitions of the transmission in at least one of the FD slot or the SBFD slot; and communicating with the node to send or receive at least one of the one or more repetitions of the transmission in at least one of the one or more available slots.

Another aspect provides a method for wireless communications by an apparatus. The method includes sending a configuration comprising: a first indication of a repetition factor indicating a minimum quantity of repetitions required for a transmission between a user equipment (UE) and the apparatus; and a second indication of at least one duplexing factor indicating a repetition count associated with at least one of a FD slot or a SBFD slot; determining one or more available slots for communicating one or more repetitions of the transmission, wherein: the one or more available slots comprise at least one of the FD slot or the SBFD slot, and a number of the one or more available slots satisfy the repetition factor when using the at least one duplexing factor to count at least one of the one or more repetitions of the transmission in at least one of the FD slot or the SBFD slot; and communicating with the UE to send or receive at least one of the one or more repetitions of the transmission in at least one of the one or more available slots.

Another aspect provides a method for wireless communications by an apparatus. The method includes receiving a configuration comprising: a first indication of a repetition factor indicating a minimum quantity of repetitions required for a transmission between a node and the apparatus; and a second indication of at least one duplexing factor indicating a repetition count associated with at least one of a FD slot or a SBFD slot; and communicating with the node to send or receive one or more repetitions of the transmission in one or more available slots including at least one of the FD slot or the SBFD slot, wherein the one or more repetitions of the transmission satisfy the repetition factor when using the at least one duplexing factor to count at least one of the one or more repetitions of the transmission in the at least one of the FD slot or the SBFD slot.

Another aspect provides a method for wireless communications by an apparatus. The method includes sending a configuration comprising: a first indication of a repetition factor indicating a minimum quantity of repetitions required for a transmission between a UE and the apparatus; and a second indication of at least one duplexing factor indicating a repetition count associated with at least one of a FD slot or a SBFD slot; and communicating with the UE to send or receive one or more repetitions of the transmission in one or more available slots including at least one of the FD slot or the SBFD slot, wherein the one or more repetitions of the transmission satisfy the repetition factor when using the at least one duplexing factor to count at least one of the one or more repetitions of the transmission in the at least one of the FD slot or the SBFD slot.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts example schemes for half-duplex communications and/or full-duplex communications.

FIG. 6 depicts example transmission repetition based on a configured repetition factor.

FIG. 7 depicts a process flow for communications in a network between a node and a user equipment for determining a transmission repetition that satisfies a configured repetition factor.

FIG. 8 depicts example transmission repetition adaptation based on slot type.

FIG. 9 depicts a method for wireless communications.

FIG. 10 depicts another method for wireless communications.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for transmission repetition adaptation based on slot type.

Transmission repetition is a technique used in wireless communications to send repetitions (e.g., replicas) of a transmission packet. For example, transmission repetition may involve re-transmitting a same transmission packet, to a same receiver, one or more times after an original transmission of the packet to the receiver. Transmission repetition may be used, in some cases, to enhance the reliability of a transmission. For example, reliability may be improved given multiple repetitions of a transmission packet may increase the probability of successful reception at a receiver of the transmission packet. Transmission repetition may enable increased communication reliability, and thus wireless coverage, for downlink, uplink, and/or sidelink communications (e.g., communications between devices, such as user equipments (UEs)).

In certain aspects, transmission repetition may be used to send multiple repetitions of a transmission packet, each in a different transmission occasion, such as a slot. For example, repetitions of an uplink packet may be transmitted in one or more slots with resources allocated for uplink communications. In certain aspects, a number of slots that may be used for transmitting repetitions of the transmission packet may be based on a repetition factor, K, which, may indicate a minimum number of consecutive repetitions of a same transmission packet that is required to achieve a certain level of reliability for the transmission packet. The repetitions of the transmission packet may be sent in a number of consecutive slots (e.g., one repetition per slot) with resources allocated for the transmission (e.g., uplink resources allocated for an uplink transmission packet, downlink resources allocated for a downlink transmission packet, etc.).

In certain aspects, a UE may be allocated communication resources for half-duplex (HD) communications. During HD communications, a UE may send signals and obtain signals, but at different times, for example, in transmission occasions that do not overlap in time (e.g., such as in different slots). As an illustrative example, a UE may be allocated a set of uplink resources in a first slot, a second slot, and a third slot for HD uplink communications in each of these slots. To achieve a certain level of relatability for an uplink transmission packet, the UE may need to transmit at least two repetitions of the uplink transmission packet (e.g., K=2). As such, the UE may determine to send the original uplink transmission packet in the first slot and then send a first repetition of the uplink transmission packet in the second slot and send a second repetition of the uplink transmission packet in the third slot.

In certain aspects, a UE may be allocated communication resources for full-duplex (FD) communications, in addition to, or alternative to communication resources allocated for HD communications. During FD communications, a UE may obtain signals and send signals simultaneously, for example, in the same transmission occasion (e.g., such as in a same slot). In some cases, a UE may be allocated subbands within the same carrier frequency of a serving cell for FD communications. For example, a UE may be allocated a first subband for downlink communications and a second subband for uplink communications in the same transmission occasion. This type of FD communications may be referred to as subband full-duplex (SBFD) communications.

The use of FD communications, including SBFD communications, may enable concurrent sending and receiving of data by a UE, which beneficially helps to speed up data transfer and thus enables lower latency communications (e.g., reduce wait times for transmitting/receiving data). Faster data transfer and lower latency may be useful for high-demand applications such as, for example, video streaming. By enabling simultaneous communication, FD communications also beneficially increase data transmission rates, thereby increasing throughput and wireless network coverage. Further, FD communications allow for a flexible slot structure which may allow for more dynamic and flexible use of the spectrum, as different slots can be configured with different proportions of downlink and uplink according to a current demand.

A technical problem associated with the use of FD communications, however, involves reliability. For example, a transmission packet sent by a UE (e.g., operating in an FD mode) in an FD slot (e.g., including in an SBFD slot) may experience interference due to (1) transmitter signal leakage (e.g., signal leakage from a terminal's output to its input, which can cause self-interference) and/or (2) adjacent subband transmissions (e.g., for SBFD communications in a slot). This interference may reduce signal quality of an FD transmission packet and thus negatively affect the ability of a receiver to receive a transmission packet. Therefore, from at least a reliability perspective, a transmission packet sent in an FD slot and/or an SBFD slot may be less reliable than a transmission packet send in an HD slot.

Conventional techniques for determining a number of slots to use for sending repetitions of a transmission packet, to satisfy a repetition factor and thus achieve a minimum reliability for the transmission packet, do not consider the slot type when determining the number of slots to use. As such, at least in cases where the transmission packet is repeated in one or more FD slots and/or one or more SBFD slots, the reliability achieved may be less than what is minimally required (e.g., the minimum reliability required per the repetition factor, K).

Certain aspects described herein overcome the aforementioned technical problems and provide a technical benefit to the field of telecommunications. For example, aspects described herein provide techniques for transmission repetition adaptation as a function of the slot type(s) carrying a transmission packet (e.g., a repeated transmission). As described in detail below, determining a number of slot(s) to use for repetition(s) of a transmission packet, such that a repetition total determined for the transmission packet satisfies a repetition factor, K, may be based on (1) a slot type of each of the slot(s) used for the repetition(s) and (2) a duplexing factor associated with each slot type. A duplexing factor may indicate a repetition count associated with the corresponding slot type that may be used when determining a total repetition for a transmission packet. According to aspects described herein, a duplexing factor associated with an HD slot may be greater than a duplexing factor associated with an FD slot and/or an SBFD slot such that a repetition of the transmission in an FD slot and/or an SBFD slot contributes less to the total repetition of the transmission packet than if the packet were transmitted in an HD slot. This reduced contribution of transmission packet repetitions sent in FD and/or SBFD slots towards the total repetition determined for the transmission packet may naturally force more repetitions of the transmission packet to be sent (e.g., in more slots).

For example, a duplexing factor (e.g., repetition count) associated with an HD slot may be equal to 1, while a duplexing factor (e.g., repetition count) associated with an FD slot may be equal to ½. By setting the duplexing factor for FD slots less than the duplexing factor for HD slots (e.g., ½<1), more repetitions of the transmission packet may be needed when the repetitions of the transmission packet are sent in FD slots, than when the repetitions of the transmission packet are sent in HD slots, to satisfy a same repetition factor, K. In particular, to reach a repetition factor K=1, one repetition of the transmission packet may need to be sent in one HD slot (e.g., (1 HD slot)*1=1, which is equal to K), while two repetitions of the transmission may need to be sent in two FD slots (e.g., (2 FD slots)*½=1, which is equal to K).

This reduced contribution of repetition transmissions of a transmission packet in FD and/or SBFD slot may be attributed to the decreased reliability associated with FD and/or SBFD transmissions. As such, a total repetition for a transmission packet may be more accurately determined, and a number of repetitions and/or slot(s) used for transmitting repetition(s) of the transmission packet may be increased in cases where FD and/or SBFD slots may be/are used to send the repetition(s) of the transmission packet. This increase in repeated transmission packets (and/or slots used to send the repeated transmission packets) may help to ensure that the reliability achieved for the transmission packet is above a minimum reliability intended for the transmission packet.

As an illustrative example, a repetition factor may be K=2 indicating that a repetition total determined for a transmission packet may need to be equal to, or greater than, 2 to achieve a minimum reliability for the transmission packet. An HD duplexing factor, v_{HD}=1, may be applied to each HD slot used to send a repetition of the transmission packet, an FD duplexing factor, v_{FD}=½, may be applied to each FD slot used to send a repetition of the transmission packet, and an SBFD duplexing factor, v_{SBFD}=½, may be applied to each SBFD slot used to send a repetition of the transmission packet. Thus, a total repetition determined for the packet may be provided as:

$$Repetition Total = {N}_{HD} \times {v}_{HD} + {N}_{SBFD} \times {v}_{SBFD} + {N}_{FD} \times {v}_{FD}$$

$$Repetition Total = {N}_{HD} \times ( 1 ) + {N}_{SBFD} \times ( 1 / 2 ) + {N}_{FD} \times ( 1 / 2 )$$

where N_{HD} represents the number of HD slot(s) that may be used for sending repetition(s) of the transmission packet, N_{SBFD} represents the number of SBFD slot(s) that may be used for sending repetition(s) of the transmission packet, and NED represents the number of FD slot(s) that may be used for sending repetition(s) of the transmission packet.

The number of HD slot(s), FD slot(s), and/or SBFD slot(s) may be determined such that the repetition total for the transmission packet is greater than or equal to the repetition factor, K (e.g., Repetition Total ≥K=2). Using a number of slots for repetition of the transmission packet that satisfies the repetition factor may help to ensure that a reliability for the transmission packet is achieved. In certain aspects, the original transmission of a transmission packet in an HD slot, an FD slot, and/or an SBFD slot may not be counted towards the repetition total. Put differently, only subsequent transmission(s) of the transmission packet (e.g., such as the second transmission of the transmission packet, the third transmission of the transmission packet, etc.) may be counted towards the repetition total. In certain other aspects, the original transmission of a transmission packet in an HD slot, an FD slot, and/or an SBFD slot may be counted towards the repetition total. Put differently, the first transmission of the transmission packet may be counted towards to the repetition total, along with any other subsequent transmission(s) of the transmission packet, to reach the repetition factor, K.

Certain techniques for transmission repetition adaptation described herein may provide various beneficial technical effects and/or advantages. The techniques for transmission repetition adaptation as a function of the slot type(s) carrying a transmission packet (e.g., a repeated transmission) may enable improved wireless communications performance, such as improved wireless communication reliability at least for FD communications. As such, the aforementioned advantages of FD communications may be realized, yet not at the cost of reduced wireless communications reliability. The improved reliability may be attributable to the use of duplexing factor(s) for FD and/or SBFD slots when determining slot(s) to use for sending repetition(s) of a transmission packet. For example, the duplexing factor(s) associated with FD and/or SBFD slots may be less than a duplexing factor associated with an HD slot to account for the reduced reliability of sending transmission packets in FD and/or SBFD slots. Thus, a total repetition determined for a transmission packet may be more accurate and help to better maintain a certain level of reliability for communications in a wireless communications network.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

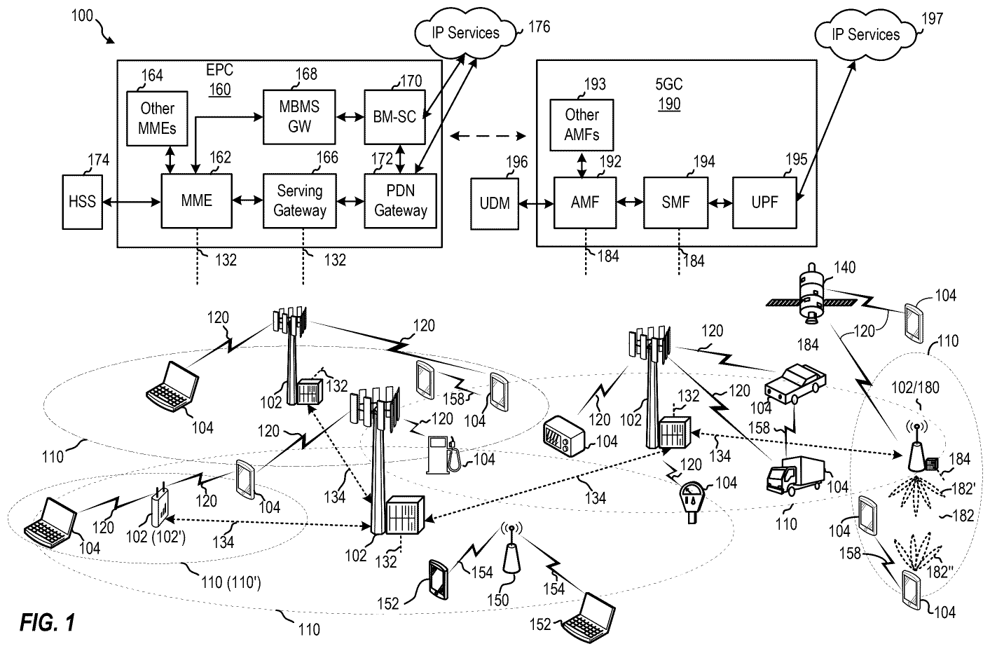

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

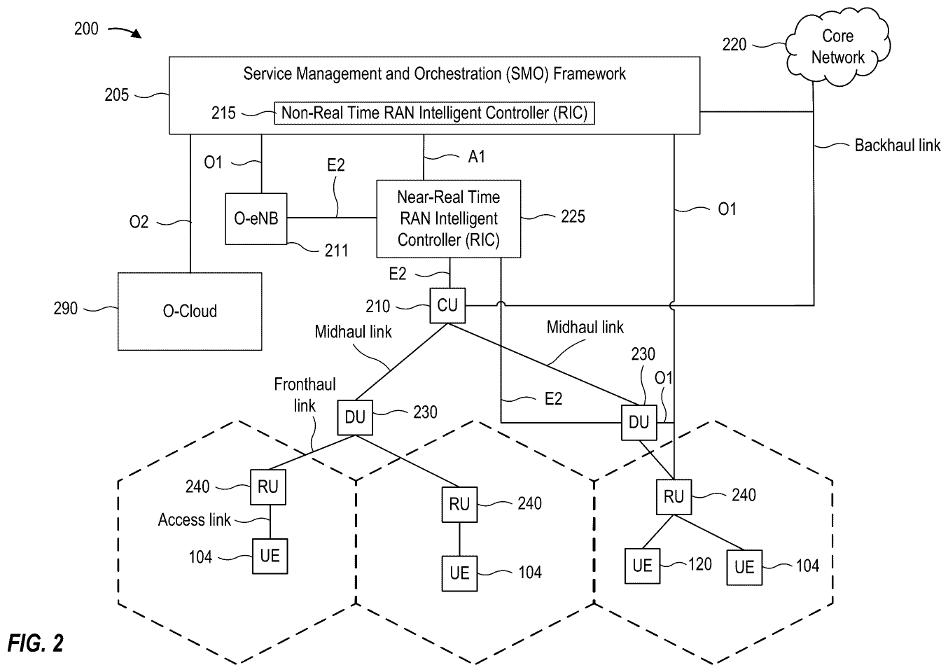

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

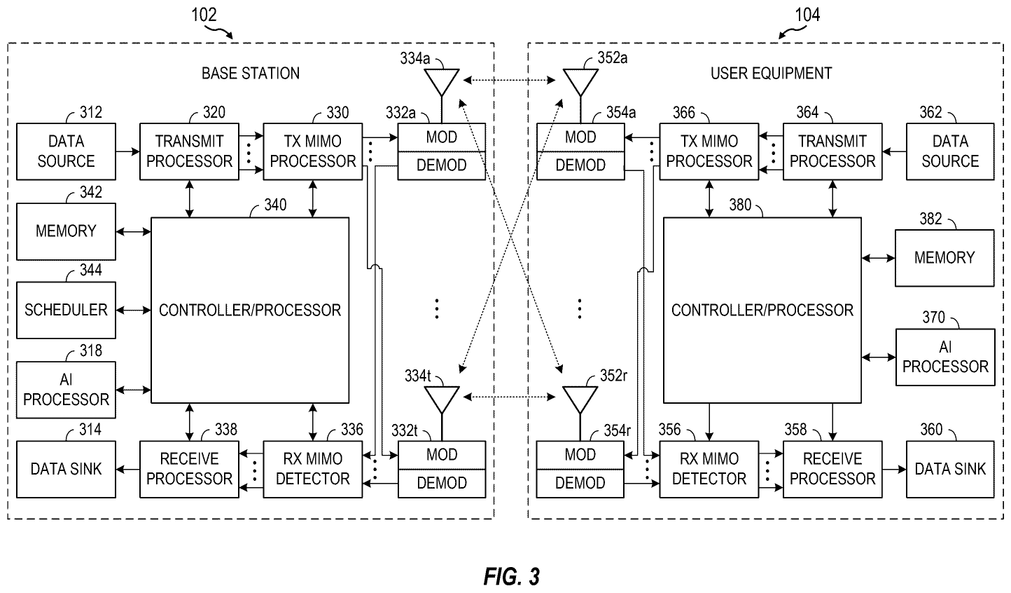

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

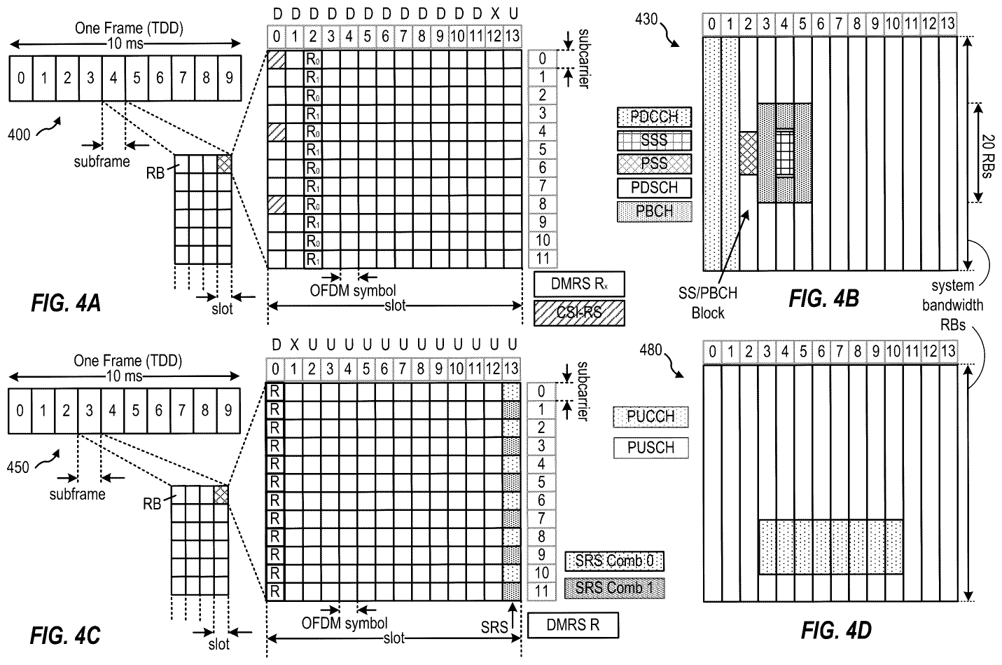

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology u, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 24×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Sidelink Communications

While communication between UEs (e.g., such as UEs 104 of FIGS. 1 and 3) and BSs (e.g., such as BSs 102 of FIGS. 1 and 3, or a disaggregated base station as discussed with respect to FIG. 2) may be referred to as the access link, and the access link may be provided via a cellular interface (e.g., Uu interface), communication between devices may be referred to as the sidelink.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, Internet of Things (IoT) communications, mission-critical mesh, and/or various other suitable applications. Generally, a sidelink signal may refer to a signal communicated from one subordinate entity (e.g., one UE 104 illustrated in FIG. 1) to another subordinate entity (e.g., another UE 104 illustrated in FIG. 1) without relaying that communication through a scheduling entity (e.g., UE 104 or BS 102 in FIG. 1), even though the scheduling entity may be utilized for scheduling and/or control purposes. In some examples, the sidelink signals may be communicated using a licensed spectrum (unlike wireless local area networks (WLANs), which typically use an unlicensed spectrum).

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and/or other parameters used for data transmissions, and the PSSCH may carry the data transmissions. PSFCH may carry feedback such as channel state information (CSI) related to a sidelink channel quality.

For the operation regarding PSSCH, a UE may perform either transmission and/or reception in a slot on a carrier. A reservation or allocation of transmission resources for a sidelink transmission is typically made on a sub-channel of a frequency band for a period of a slot. NR sidelink supports, for a UE, a case where all the symbols in a slot may be available for sidelink, as well as another case, where only a subset of consecutive symbols in a slot may be available for sidelink.

According to previously known techniques, resource allocation is reservation based in NR sidelink communications. In these techniques, resource allocations are made in units of sub-channels in the frequency domain and are limited to one slot in the time domain. Further, a transmission may reserve resources in the current slot and in up to two future slots. Reservation information may be carried in sidelink control information (SCI). In the previously known techniques, SCI may be transmitted in two stages. A first stage SCI (SCI-1) may be transmitted on a PSCCH and may contain resource reservation information as well as information needed to decode a second stage SCI (SCI-2). An SCI-2 may be transmitted on the PSSCH and may contain information needed to decode data on the shared channel and to provide feedback (e.g., acknowledgments (ACKs) or negative acknowledgments (NACKs)) over the PSFCH.

### Example Duplex Modes

A wireless communications system, such as wireless communications network 100 in FIG. 1, may support various duplex modes. As used herein, the term “duplex mode” may refer to an operational mode of a device (e.g., a scheduled entity, such as UE 104 of FIGS. 1 and 3). Example duplex modes may an HD mode and/or an FD mode.

A device operating in an HD mode may send and receive data, but only one at a time. For example, for HD communications between two HD mode operating devices, data may be sent between both devices in both directions (e.g., bi-directional communication), but the data may only travel in one direction at a time. Once one device has finished transmitting its data, the other device may then send data in response.

Alternatively, an FD mode operating device may transmit and receive data simultaneously. For example, for FD communications between two FD mode operating devices, data may be sent between both devices in both directions (e.g., bi-directional communication) and at the same time.

Two types of FD modes include (1) an in-band FD (IBFD) mode and (2) an SBFD mode. When operating in an IBFD mode, two devices may transmit and receive using the same or overlapping time and frequency resources. For example, a UE may be in communication with a network entity. The UE may be allocated a set of uplink resources and a set of downlink resources for communication with the network entity, where there is a full or partial overlap in the uplink and downlink resources. When operating in an SBFD mode, two devices may transmit and receive at the same time (e.g., in a same transmission occasion) but using different frequency resources. For example, a UE may be in communication with a network entity. The UE may be allocated a set of uplink resources and a set of downlink resources in a same slot for communication with the network entity. However, in the slot, the downlink resources may be separated from the uplink resources in the frequency domain.

A device may be operating in an HD mode or an FD mode for uplink communications, downlink communications, and/or sidelink communications.

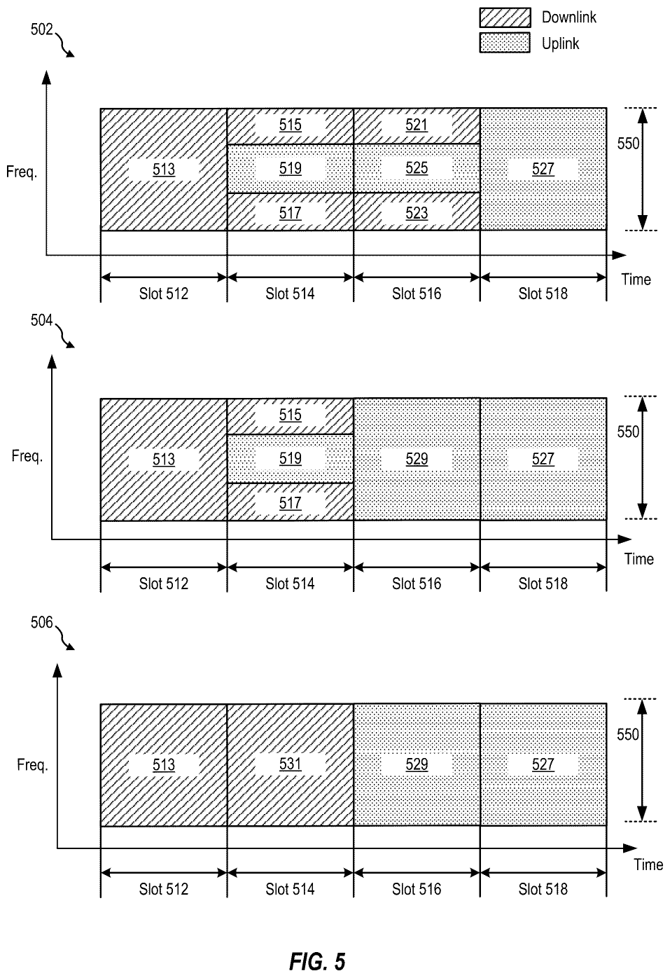

FIG. 5 depicts example schemes 502, 504, 506 for HD, FD, and SBFD communications.

In example scheme 502 (e.g., an example time division duplexing (TDD) structure), a UE may be allocated a first set of downlink resources 513 for HD downlink communications in a first transmission occasion, such as slot 512. The first set of downlink resources 513 may occupy a carrier 550 defined by a frequency bandwidth.

In a second transmission occasion, e.g., slot 514, the UE may be allocated a second set of downlink resources 515, a third set of downlink resources 517, and a first set of uplink resources 519. The first set of uplink resources 519 may be arranged between the second set of downlink resources 515 and the third set of downlink resources 517 in the frequency domain. In certain aspects, a guard band may be arranged between second set of downlink resources 515 and the first set of uplink resources 519 in the frequency domain, and between the first set of uplink resources 519 and the third set of downlink resources 517 in the frequency domain. In certain aspects, each of the second set of downlink resources 515, the third set of downlink resources 517, and the first set of uplink resources 519 may occupy a subband (e.g., a bandwidth part (BWP)) of the carrier 550. The second set of downlink resources 515, the third set of downlink resources 517, and the first set of uplink resources 519 may form subbands for SBFD communications. In certain aspects, an SBFD configuration (or allocation) of the second set of downlink resources 515, the third set of downlink resources 517, and the first set of uplink resources 519 may be referred to as an SBFD mode.

Similar to the second transmission occasion (e.g., slot 514), in a third transmission occasion, e.g., slot 516, the UE may be allocated a fourth set of downlink resources 521, a fifth set of downlink resources 523, and a second set of uplink resources 525. The second set of uplink resources 525 may be arranged between the fourth set of downlink resources 521 and the fifth set of downlink resources 523 in the frequency domain. The fourth set of downlink resources 521, the fifth set of downlink resources 523, and the second set of uplink resources 525 may form subbands for SBFD communications.

In a fourth transmission occasion, e.g., slot 514, the UE may be allocated a third set of uplink resources 527 for HD uplink communications. The third set of uplink resources 527 may occupy the carrier 550.

In scheme 502, because the UE is allocated resources for HD communications in slot 512 and slot 518, slot 512 and 518 may be referred to herein as “HD slots.” Further, because the UE is allocated resources for SBFD communications in slot 514 and slot 516, slot 514 and slot 516 may be referred to herein as “SBFD slots.”

In scheme 504 (e.g., another example TDD structure), resources allocated in slot 512, slot 514, and slot 518 are similar to resources allocated in scheme 502. Resources allocated in the third transmission occasion, e.g., slot 516, however, are different than the resources allocated in scheme 502. For example, in slot 516 in scheme 504, the UE may be allocated a fourth set of uplink resources 529 for HD uplink communications. The fourth set of uplink resources 529 may occupy the carrier 550. Thus, in scheme 504, three slots (e.g., slots 512, 516, and 518) may be HD slots and one slot (e.g., slot 514) may be an SBFD slot.

In scheme 506 (e.g., another example TDD structure), resources allocated in slot 512, slot 516, and slot 518 are similar to resources allocated in scheme 504. Resources allocated in the second transmission occasion, e.g., slot 514, however, are different than the resources allocated in scheme 504. For example, in slot 514 in scheme 506, the UE may be allocated a sixth set of downlink resources 531 for HD downlink communications. The sixth set of downlink resources 531 may occupy the carrier 550. Thus, in scheme 506, all four slots (e.g., slots 512, 514, 516, and 518) may be HD slots (e.g., no SBFD slots may exist).

Note that the schemes 502, 504, 506 depicted in FIG. 5 are examples to facilitate an understanding of HD, FD, and SBFD communications. Other resource allocations or arrangements for HD, FD, and/or SBFD communications may be used in accordance with the present disclosure.

In certain aspects, FD communications may be configured across multiple carriers (e.g., the carrier 550). For example, a UE may be allocated a downlink resources in a first carrier and uplink resources in a second carrier. Such a FD configuration (or allocation) may be referred to as a FD mode.

As described above, the use of FD communications, such as SBFD communications, may allow for increased data speeds, enable lower latency communications, enable flexible downlink and/or uplink resource allocation, and increase wireless coverage. While the allocation of resources for FD transmissions in a slot may be desired for one or more of the aforementioned reasons, FD transmissions, including SBFD transmissions, may experience degraded signal quality. In certain aspects, the degraded signal quality may attributed to interference in a communications channel. For example, FD transmissions, and more specifically SBFD transmissions, may suffer from inter-subband self-interference. Inter-subband self-interference may occur when reception of a first signal by a device in one subband is interfered by the transmission, by the device, of another signal in a same transmission occasion (e.g., in a same slot). Put differently, adjacent subband transmissions may cause interference to receptions at the device.

Further, in certain aspects, the degraded signal quality may be attributed to transmitter signal leakage. For example, in FD operation, a radio transceiver of a device may receive and transmit signals simultaneously. In some cases, the transmitter of the transceiver may output signals at a power level much higher than that of signals received at the device. Thus, a receiver section of the transceiver may suffer self-interference from the transmitter, which may be referred to as “transmitter signal leakage.” In some cases, the transmitter signal leakage may be based on a duplexer filter, used to allow the receiver and transmitter to share an antenna, providing only limited isolation between the transmitter and receiver paths for the device.

Due to the interference resulting during FD operation, including SBFD operation, the signal quality may be lower for FD transmissions (e.g., including SBFD transmissions) in FD slots than for HD transmissions in HD slots. Therefore, from at least a reliability perspective, an HD transmission in an HD slot may be superior to an FD transmission in an FD slot (e.g., such as an SBFD transmission in an SBFD slot). Put differently, an HD transmission in an HD slot may be more reliable than an FD transmission in an FD slot and an SBFD transmission in an SBFD slot.

### Example Transmission Repetition Based on a Configured Repetition Factor

In certain aspects, transmission repetition is used for downlink and/or uplink communications to increase the reliability of communications between a network entity (e.g., such as BS 102 of FIGS. 1 and 3, or a disaggregated base station as discussed with respect to FIG. 2) and a UE (e.g., such as UE 104 of FIGS. 1 and 3), and thus improve wireless coverage. In certain aspects, transmission repetition is used for sidelink communications to increase the reliability of communications between two UEs, and thus further improve the wireless coverage.

For example, for uplink communications, a UE may receive, from a network entity, a configured grant (CG) pre-allocating resources to the UE for uplink packet transmission. Unlike a dynamic grant (DG), with a CG, a UE may not need to send a scheduling request (SR) to the network entity to receive the UL grant with resource allocation. In certain aspects, in addition to scheduling resources for uplink transmission by the UE, the CG may include an indication of a repetition factor, K, to use for uplink communication. The repetition factor, K, may indicate a minimum number of consecutive repetitions of a same transmission packet, over a number of consecutive available slots and/or sub-slots (e.g., configured for uplink communications), that is required to achieve a particular level of reliability with respect to uplink communications.

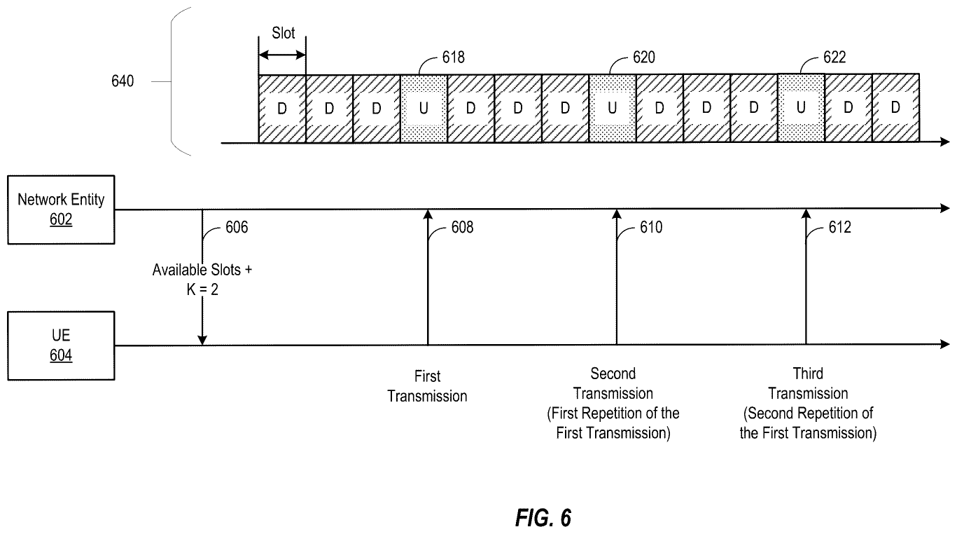

In some cases, each repetition, of a same transmission packet, in a slot (irrespective of the slot type, such as an HD slot, FD slot, etc.) may be counted as a single repetition towards the total repetitions required. For example, a re-transmission of a transmission packet in two slots (e.g., where each slot is configured for at least uplink communications) may obtain a repetition value of two. Thus, in cases where, the repetition factor K=2, then the repetition factor may be satisfied by sending two replicas of the transmission packet in the two slots. Satisfying the repetition factor may indicate that a level or reliability associated with the repetition factor has been met for the packet. This scenario is illustrated in FIG. 6.

FIG. 6 depicts a process flow 600 for communications in a network between a network entity 602 and a UE 604. In certain aspects, the network entity 602 may be an example of the BS 102 depicted and described with respect to FIGS. 1 and 3 or a disaggregated base station depicted and described with respect to FIG. 2. In certain aspects, the UE 604 may be an example of the UE 104 depicted and described with respect to FIGS. 1 and 3. However, in other aspects, UE 604 may be another type of wireless communications device and network entity 602 may be another type of wireless communications device, network entity, or network node, such as those described herein.

As shown in FIG. 6, process flow 600 begins at 606 with network entity 602 sending, to UE 604, a configuration of a plurality of available slots. As used herein, an “available slot” may refer to a candidate slot available (or scheduled) for the transmission of a channel. In this example, an “available slot” may refer to a candidate slot available for the transmission of a PUCCH or a PUSCH (e.g., available/scheduled for at least uplink communications). In the example slot pattern 640 shown in FIG. 6, the available slots may include slots 618, 620, and 622. For example, UE 604 may be allocated uplink resources for HD uplink communications in slots 618, 620, and 622 (additionally UE 604 may be allocated downlink resources for HD downlink communication in the other slots of the slot pattern). Slots 618, 620, and 622 may be similar to slot 518 in scheme 502, slots 516 and 518 in scheme 504, and/or slots 516 and 518 in scheme 506 depicted and described above with respect to FIG. 5.

Further, at 606, network entity 602 sends, to UE 604, an indication of a repetition factor, K. In this example, repetition factor K=2, thereby indicating to UE 604 that a minimum of two repetitions are required for an uplink transmission (e.g., the “first transmission” shown in FIG. 6) sent from UE 604 to network entity 602. Based on this repetition factor, UE 604 may determine to send, at 608, a first transmission of the transmission packet in slot 618 (e.g., the first in time available slot scheduled for at least uplink communications) and then (1) send, at 610, a first repetition of the transmission packet (e.g., a second transmission of the transmission packet) in slot 620 (e.g., the second in time available slot scheduled for at least uplink communications) and (2) send, at 612, a second repetition of the transmission packet (e.g., a third transmission of the transmission packet) in slot 622 (e.g., the third in time available slot scheduled for at least uplink communications). For example, each available slot used for a repetition (e.g., in this case, a subsequent transmission) of the first transmission may contribute a value of ‘1’ to the total repetition. Thus, by sending a first repetition (e.g., a second transmission of the transmission packet) in slot 620 and a second repetition (e.g., a third transmission of the transmission packet) in slot 622, the total repetition may be equal to 2, which is equal to the repetition factor K=2. Thus, UE 604 determining to send replicas of the first transmission in slots 620, 622 satisfies the repetition factor.

Although in the example illustrated in FIG. 6, the initial (e.g., the first) transmission of the transmission packet, at 608 in slot 618, is not counted towards the total repetition count for the transmission packet, in some other examples, the initial transmission may be counted towards the total repetition count. Accordingly, the initial transmission of the transmission packet may be used to help reach the repetition factor, K.

At 608, UE 604 sends the transmission packet to network entity 602. In certain aspects, UE 604 further sends, at 610 and 612, the first repetition of the transmission packet in slot 620 and the second repetition of the transmission packet in slot 622, respectively. In certain other aspects, however, the first repetition of the transmission packet in slot 620 and/or the second repetition of the first transmission in slot 622 may not be sent by UE 604. For example, UE 604 may determine to drop one of the transmission packet repetitions based on one or more PUSCH dropping rules. For example, UE 604 may determine to drop one of the transmission packet repetitions based on a dynamic slot format indicator (SFI), a grant for a higher priority channel, etc. The dropped transmission packet repetition(s), however, may continue to be counted towards the total repetition for the transmission packet such that the repetition factor is satisfied.

In the example illustrated in FIG. 6, UE 604 may transmit the repetitions of the transmission packet only in HD uplink slots (e.g., slot 620 and 622). Put differently, UE 604 is only allocated resources for HD uplink communications in slot 620 and 622.

In some other cases, however, UE 604 may be allocated resources for FD uplink communications in FD slots and/or in SBFD slots (e.g., as shown in slots 514, 516 in scheme 502 in FIG. 5, as well as in slot 514 in scheme 504 in FIG. 5). Thus, UE 604 may determine to send repetitions of the transmission packet in one or more FD slots and/or one or more SBFD slots to satisfy a repetition factor, K, and achieve a level of reliability associated with the repetition factor.

As described above, however, each of an FD transmission in an FD slot and an SBFD transmission in an SBFD slot may be less reliable than an HD transmission in an HD slot, at least due to a higher interference level (e.g., lower signal to interference plus noise ratio (SINR)) experienced during FD operation than in HD operation. Thus, repetition of a transmission packet in one or more FD slots and/or one or more SBFD slots may not achieve a same reliability as a transmission packet that is repeated across consecutive HD only slots (e.g., for uplink communications or downlink communications).

As an illustrative example, returning to FIG. 5, in scheme 502, an uplink slot transmission (previously sent and not shown) may be repeated across three slots, such as slots 514, 516, and 518 (e.g., via uplink resources allocated for each slot). The three slots may include two SBFD slots (e.g., slots 514 and 516) and one HD slot (e.g., slot 518).

In scheme 504, the uplink slot transmission may also be repeated across three slots, such as slots 514, 516, and 518. The three slots may include one SBFD slot (e.g., slot 514) and two HD slots (e.g., slots 516 and 518).

In scheme 506, the uplink slot tot transmission may be repeated across only two slots, such as slots 516 and 518. The two slots may include two HD slots.

A reliability achieved for the uplink slot transmission in scheme 504 may be greater than a reliability achieved for the uplink slot transmission in scheme 502. For example, although three slots may be used to send repetitions of the uplink slot transmission in both schemes 502 and 504, (1) a number of HD slots used for the transmission repetition is greater in scheme 504 than in scheme 502 and (2) a number of SBFD slots used for the transmission repetition is less in scheme 504 than in scheme 502. A greater number of HD slots and/or a lesser number of SBFD slots (e.g., when the number of slots used for repetition are the same) used for transmission repetition may contribute to a greater overall reliability achieved for the transmission. This may be due to the higher level of interference generally experienced by SBFD/FD slot transmissions than HD slot transmissions.

In this example, whether a reliability achieved for the uplink slot transmission in scheme 502 is more or less reliable than a reliability achieved for the uplink slot transmission in scheme 506 may be based at least in part on (1) the FD interference level experienced in scheme 504 (e.g., for slot 514, which is an SBFD slot), (2) the cancellation gain achieved in slot 514 in scheme 504, and/or (3) the allocation size for the data in terms of bandwidth (e.g., generally configured by a number of RBs). For example, while a number of slots used for repetitions in scheme 502 is greater than a number of slots used for repetitions in scheme 506 (e.g., three slots >two slots), two of the slots in scheme 502 are SBFD slots. Thus, the interference experienced by a transmission in each SBFD slot may need to be taken into consideration when determining the overall reliability achieved for scheme 502, and further whether this reliability is greater than the overall reliability achieved for scheme 506.

### Aspects Related to Transmission Repetition Adaptation Based on Slot Type

Aspects described herein relate to techniques for transmission repetition adaptation as a function of the slot type(s) carrying a transmission packet (e.g., a repeated transmission packet). For example, aspects described herein provide duplexing factor(s), associated with FD and/or SBFD slots, which may be used when determining a total repetition achieved for a transmission packet. Each duplexing factor may indicate a repetition count associated with an FD and/or SBFD slot that may be counted towards a total repetition determined for a transmission packet when the transmission packet is repeated (e.g., re-sent) in an FD and/or SBFD slot.

In certain aspects, the duplexing factor(s), associated with FD and/or SBFD slots, may be less than a duplexing factor associated with an HD slot. Put differently, a repetition count associated with a repeated transmission packet (and/or the initial transmission packet) sent in an FD and/or SBFD slot may be smaller than a repetition count associated with a repeated transmission packet (and/or the initial transmission packet) sent in an HD slot. For example, the repetition count associated with a repeated transmission packet (and/or the initial transmission packet) sent in an HD slot may equal to one (e.g., similar to legacy cases for repetition counting), while a repetition count associated with a repeated transmission packet (and/or the initial transmission packet) sent in an FD and/or SBFD slot may be less than one (e.g., ½, ¼, etc.). Accordingly, from a repetition counting perspective, by setting the repetition count for FD and/or SBFD slots less than one (e.g., less than a repetition count for HD slots), if repetition(s) of a transmission packet are sent in FD and/or SBFD slot(s), then more repetitions of the transmission packet may be needed such that a repetition total determined for the transmission packet is at least the repetition factor, K (e.g., repetition total for the transmission packet ≥K).

For example, to reach a repetition factor K=2 for a transmission packet, a transmission packet may need to be sent in two HD slots (e.g., assuming a duplexing factor/repetition count of 1 for the HD slots). Specifically, (2 HD slots)*(1)=2, which is equal to K=2. But to reach a repetition factor K=2 for a transmission packet transmitted in FD slots, the transmission packet may need to be sent in four FD slots (e.g., assuming a duplexing factor/repetition count of ½ for FD Slots). Specifically, (4 FD Slots)*(½)=2, which is equal to K=2. Thus, the smaller duplexing factor/repetition count for FD slots (and/or SBFD slots) may naturally force more repetitions of the transmission packet to reach the repetition factor, K. The reduction in the duplexing factor/repetition count for FD slots and/or SBFD slots may help to account for the reduced reliability of such slot transmissions when determining whether a certain level of reliability has been achieved for the transmission packet (e.g., based on sending one or more repetitions of the transmission packet).

As described above, in certain aspects, repetition(s) of a transmission packet may refer to only subsequent transmission(s) of a transmission packet (e.g., the second, third, etc. transmissions of a transmission packet, and not including the first transmission of the transmission packet). However, in certain other aspects, repetition(s) of a transmission packet may include the initial transmission of the transmission packet (e.g., the first transmission) along with subsequent transmission(s) of the transmission packet (e.g., the second, third, etc. transmissions).

In certain aspects, a number of available slots to use for sending repetitions of a transmission packet may be determined. For example, a number of consecutive available slots to use for sending repetitions of a transmission packet may be determined by calculating a repetition factor for the transmission packet based on the different slot types of the available slots. An available FD and/or SBFD slot may count less towards the total repetition than an available HD slot, thus naturally forcing more repetitions of the transmission packet to be sent when sent in an FD and/or SBFD slot. A number of consecutive available slots that achieves a total repetition equal to or greater than a configured repetition factor, K, (e.g., total repetition ≥K) may be used to send repetitions of the transmission packet. As such, a minimum level of reliability associated with the repetition factor, K, may be achieved if the transmission packet is repeated in the determined number of available of consecutive slots.

In certain aspects, the transmission packet is, in fact, repeated in each of the consecutive available slots such that the repetitions of the transmission packet achieve the repetition factor, and thus the minimum reliability is maintained. In certain other aspects, the transmission packet is not repeated in each of the consecutive available for one or more reasons. For example, as described above with respect to FIG. 6, a node may determine to drop one or more of the transmission packet repetitions in one or more of the available slots based on a dynamic SFI, a grant for a higher priority channel, etc. However, in some cases, the dropped transmission packet repetition(s) may continue to be counted towards the total repetition for the transmission packet such that the repetition factor is satisfied and the minimum reliability is achieved.

### Example Signaling for Transmission Repetition

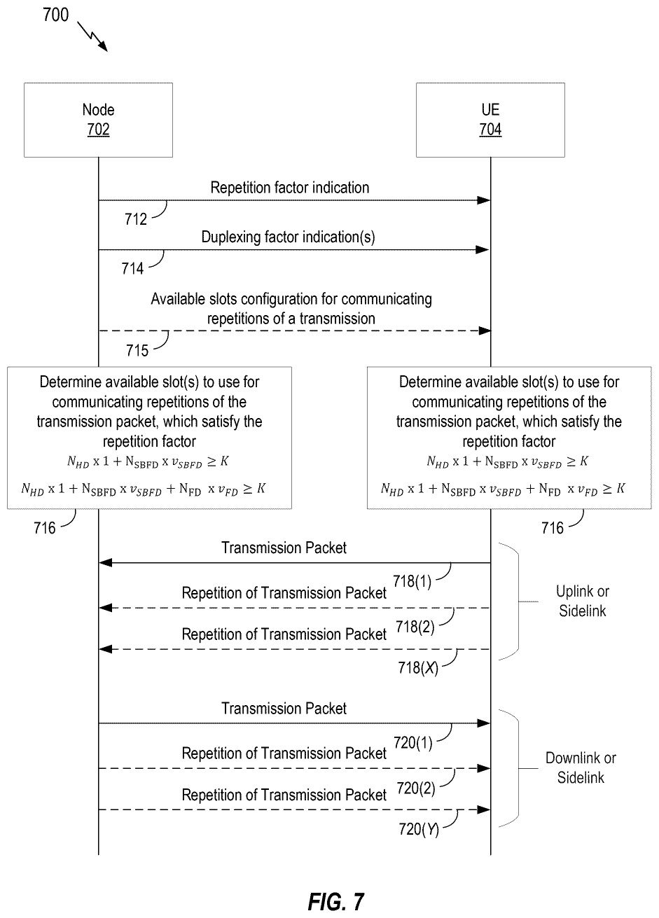

FIG. 7 depicts a process flow 700 for communications in a network between a node 702 and a UE 704. In certain aspects, the node 702 may be an example of the BS 102 depicted and described with respect to FIGS. 1 and 3 or a disaggregated base station depicted and described with respect to FIG. 2. In certain aspects, the node 702 may be an example of the BS 102 depicted and described with respect to FIGS. 1 and 3 or a disaggregated base station depicted and described with respect to FIG. 2. Similarly, the UE 704 may be an example of the UE 104 depicted and described with respect to FIGS. 1 and 3. However, in other aspects, UE 704 may be another type of wireless communications device and node 702 may be another type of wireless communications device, network entity, or network node, such as those described herein. Note that any operations or signaling illustrated with dashed lines may indicate that that operation or signaling is an optional or alternative example.

In certain aspects, process flow 700 is used to determine a number of consecutive available slots to use for sending repetitions of a transmission packet such that a certain level of reliability is achieved for the transmission packet. In certain aspects, the number of consecutive available slots is determined based on a slot type of each of the consecutive slots, which may each be used to send a repetition of the transmission packet, and a duplexing factor associated with each slot type.

Process flow 700 begins, at 712, with node 702 sending, to UE 704, an indication of a repetition factor, K, indicating a minimum quantity of repetitions required for a transmission packet between node 702 and UE 704. For example, UE 704 may receive a configuration with the indication of the repetition factor, K. In certain aspects, node 702 is a network entity, and the repetition factor, K, may indicate a minimum number of repetitions of an uplink transmission packet (e.g., sent by UE 704 to the network entity) needed to achieve a certain level of reliability for the uplink transmission packet. In certain aspects, the uplink transmission is a physical random access channel (PRACH) transmission packet or a PUSCH transmission packet, among others.

In certain other aspects, node 702 is a network entity, and the repetition factor, K, may indicate a minimum number of repetitions of a downlink transmission packet (e.g., sent by the network entity to UE 704) needed to achieve a certain level of reliability for the downlink transmission packet. In certain aspects, the downlink transmission packet is a PDSCH transmission packet.

In certain other aspects, node 702 is another UE, and the repetition factor, K, may indicate a minimum number of repetitions of a sidelink transmission packet (e.g., to be transmitted between UE 704 and the other UE) needed to achieve a certain level of reliability for the sidelink transmission. In certain aspects, the sidelink transmission packet is a sidelink PUSCH transmission packet.

Process flow 700 proceeds, at 710, with node 702 sending, to UE 704, an indication of at least one duplexing factor, v. For example, UE 704 may receive a configuration with the indication of the at least one duplexing factor, factor, v. In certain aspects, node 702 sends an indication of a single duplexing factor, v, indicating a repetition count associated with both an FD slot and an SBFD slot. In certain other aspects, node 702 sends an indication of at least two duplexing factors. For example, a first duplexing factor, v_{FD}, (also referred to herein as an “FD duplexing factor”) sent by node 702 may indicate a repetition count associated with an FD slot. A second duplexing factor, v_{SBFD}, (also referred to herein as an “SBFD duplexing factor”) sent by node 702 may indicate a repetition count associated with an SBFD slot. In certain aspects, the FD duplexing factor, v_{FD}, and the SBFD duplexing factor, v_{SBFD}, are the same. For example the FD duplexing factor may be v_{FD}=½, and the SBFD duplexing factor may be v_{SBFD}=½. In certain aspects, the FD duplexing factor, v_{FD}, and the SBFD duplexing factor, v_{SBFD}, are different. For example the FD duplexing factor may be v_{FD}=⅓, and the SBFD duplexing factor may be v_{SBFD}=½.

An indication of a duplexing factor, v_{HD}, associated with an HD slot may not be sent to UE 704. Instead, UE 704 may use a default duplexing factor, v_{Default}, such as v_{Default}=1, for repetition counting when a repeated transmission packet is sent in the HD slot. That is, a repetition of a transmission packet sent in an HD slot may be counted as “1” towards the total repetition determined for the transmission packet.

In certain aspects, the duplexing factor(s), v, sent to UE 704 at 710, may be less than a default duplexing factor, v_{Default}, which may be equal to one (e.g., v_{Default}=1). The default duplexing factor, v Default, may indicate a repetition count associated with an HD slot. The duplexing factor(s), v, sent to UE 704 at 710, may be less than the default duplexing factor, v_{Default}, to account for any reduction in reliability when sending a repetition of a transmission packet in an SBFD slot or and FD slot, instead of and HD slot. For example, a repetition of a transmission packet in an SBFD slot may be counted as, v<1 when determining a total repetition for the transmission, while a repetition of the same transmission packet in an HD slot may be counted as, v=1 when determining a total repetition for the transmission packet. As such, sending a repeated transmission packet in the HD slot may contribute more to the total repetition determined for the transmission packet than a repeated transmission packet sent in an SBFD slot (and same for an FD slot).

In certain aspects, the indication of a duplexing factor, v, sent to UE 704 comprises an indication of an index associated with the duplexing factor, v. For example, multiple duplexing factor values may be discrete and specified in wireless communications standards, such as 3GPP wireless standards. Each duplexing factor may be associated with a duplexing factor index. Example association between duplexing factor indexes and duplexing factor values is provided in the table below:

| Duplexing Factor Index | Duplexing Factor Value (v) |
|---|---|
| 0 | ¼ |
| 1 | ⅓ |
| 2 | ½ |
| 3 | ¾ |

This association may be specified in wireless communications standards. Thus, when UE 704 receives, at 714, a duplexing factor index, UE 704 may use the duplexing factor index and the association between duplexing factor indexes and duplexing factor values to determine a duplexing factor value to use for repetition counting (e.g., for an FD slot and/or an SBFD slot).

In certain aspects, an indication of a duplexing factor, v, associated with an SBFD slot or an FD slot may not be sent to UE 704. In such cases, UE 704 may use a default duplexing factor, v_{Default}, (e.g., such as v_{Default}=1) for repetition counting when a repeated transmission packet is sent in the SBFD slot or the FD slot.

In certain aspects, the configuration including the duplexing factor(s), sent to UE 704 at 714, is a semi-static configuration. In certain other aspects, the configuration including the duplexing factor(s), sent to UE 704 at 714, is a dynamic configuration. A dynamic configuration may be used to dynamically adapt the value of the duplexing factor(s) (e.g., associated with an SBFD slot and/or an FD slot) as the interference level experienced during SBFD and/or FD operations changes. The interference level may changed based on several factors including a change in network load, a change in neighbor interfering UEs, etc.

In certain aspects, the configuration including the duplexing factor(s), sent to UE 704 at 714, is a broadcast transmission (e.g., sent to multiple UEs, including UE 704). In certain aspects, the configuration including the duplexing factor(s), sent to UE 704 at 714, is a multicast transmission sent to a group of UEs, including UE 704. In certain aspects, the configuration including the duplexing factor(s), sent to UE 704 at 714, is unicast transmission sent only to UE 704.

As described above, in certain aspects, node 702 is a network entity. Thus, the configuration including the duplexing factor(s), sent to UE 704 at 714, may be sent via radio resource control (RRC) signaling, a medium access control control element (MAC-CE), downlink control information (DCI), a master information block (MIB), and/or a system information block (SIB). In certain aspects, the configuration including the duplexing factor(s), sent to UE 704 at 714, may be sent as a parameter in a DG or a CG. In certain aspects, the configuration including the duplexing factor(s), sent to UE 704 at 714, may be sent as a parameter in a MAC-CE activation signal associated with a CG. For example, the MAC-CE activation signal may include additional configuration parameters, such as the duplexing factor(s).

As described above, in certain aspects, node 702 is another UE (e.g., sidelink communications occur between node 702 and UE 704). Thus, the configuration including the duplexing factor(s), sent to UE 704 at 714, may be sent via sidelink RRC signaling, SCI-1, and/or SCI-2.

In certain aspects, the repetition factor and the duplexing factor(s) are dynamically configured or semi-statically configured at UE 704. For example, a duplexing factor, v, associated with an SBFD slot and/or an FD slot may be channel-specific. For example, a duplexing factor, v, indicated to UE 704 for a DG/CG PUSCH transmission may be different than a duplexing factor, v, indicated to UE 704 for a PRACH transmission.

It is noted that although FIG. 7 depicts the repetition factor, K, indication and the duplexing factor, v, indication(s) being sent separately to UE 704, in some cases, a single configuration including both indications may be sent to UE 704.

Process flow 700 then proceeds, at 715, with an optional step. At 715, node 702 may send, to UE 704, an available slots configuration identifying multiple slots that may be used for communicating repetitions of the transmission packet (e.g., the downlink transmission packet, the uplink transmission packet, or the sidelink transmission packet). An example available slots configuration is shown in FIG. 6. However, in this example, one or more slots in the available slots configuration may include one or more SBFD slots and/or one or more FD slots.

At 716, node 702 and UE 704 each determine available slot(s) to use for communicating repetitions of the transmission packet, which satisfy the repetition factor, K. For example, UE 704 may determine a number of consecutive available slot(s) to use for sending or receiving repetition(s) of the transmission packet. Similarly, node 702 may determine a number of consecutive available slot(s) to use for sending and/or receiving repetition(s) of the transmission packet. Node 702 and UE 704 may each determine the number of consecutive available slot(s) to use based on (1) the repetition factor, K, (2) the indicated duplexing factor(s), v, and (3) the slot type of each available slot. Node 702 and UE 704 may each determine the number of consecutive available slot(s) to use such that the transmission(s)/reception(s) between node 702 and UE 704 are aligned.

In certain aspects, the available slot(s) to use for communicating repetitions of the transmission packet include only HD slot(s) and SBFD slot(s). As such the number of consecutive available slot(s) to use for sending/receiving repetition(s) of the transmission packet may need to satisfy the condition:

$${N}_{H D} \times 1 + {N}_{S B F D} \times {v}_{S B F D} \geq K$$

where N_{HD} represents the number of HD slot(s) that may be used for sending/receiving repetition(s) of the transmission packet, N_{SBFD} represents the number of SBFD slot(s) that may be used for sending/receiving repetition(s) of the transmission packet, K represents the repetition factor, and v_{SBFD} represents the SBFD duplexing factor. The SBFD duplexing factor may indicate a repetition count associated with an SBFD slot.

In certain aspects, the available slot(s) to use for communicating repetitions of the transmission packet include HD slot(s), FD slot(s), and SBFD slot(s). As such the number of consecutive available slot(s) to use for sending/receiving repetition(s) of the transmission packet may need to satisfy the condition:

$${N}_{H D} \times 1 + {N}_{SBFD} \times {v}_{SBFD} + {N}_{F D} \times {v}_{F D} \geq K$$

where N_{HD} represents the number of HD slot(s) that may be used for sending/receiving repetition(s) of the transmission packet, N_{SBFD} represents the number of SBFD slot(s) that may be used for sending/receiving repetition(s) of the transmission packet, N_{FD} represents the number of FD slot(s) that may be used for sending/receiving repetition(s) of the transmission packet, K represents the repetition factor, v_{SBFD} represents the SBFD duplexing factor, and v_{FD} represents the FD duplexing factor. The SBFD duplexing factor may indicate a repetition count associated with an SBFD slot. The FD duplexing factor may indicate a repetition count associated with an FD slot. As described above, in certain aspects, the SBFD duplexing factor, v_{SBFD}, and the FD duplexing factor, v_{FD}, are the same (e.g., both equal to ½).

As described above, repetition(s) of a transmission packet may include (1) only subsequent transmission(s)/reception(s) of the transmission packet or (2) the initial transmission/reception and subsequent transmission(s)/reception(s) of the transmission packet. Thus, in certain aspects, an HD slot, an FD slot, and/or an SBFD slot used to send/receive an initial transmission of a transmission packet (1) may not be counted in the above equations (e.g., not counted as part of N_{HD}, NED, and/or N_{SBFD}), while in certain other aspects, an HD slot, an FD slot, and/or an SBFD slot used to send/receive the initial transmission of the transmission packet (2) may be counted in the above equations.

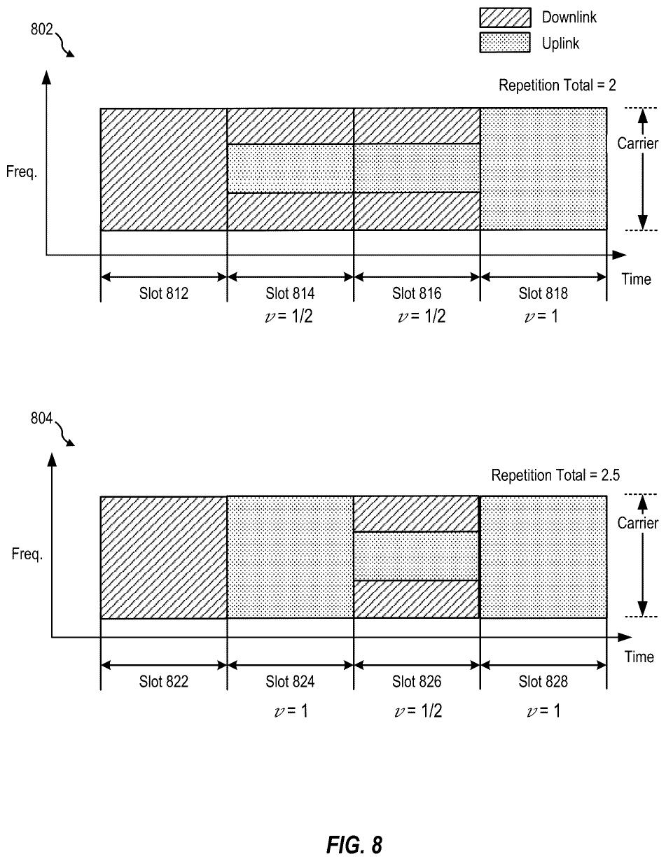

Various examples for determining the available slots for sending repetition(s) of a transmission packet are depicted and described with respect to FIG. 8 below.

In certain aspects, the transmission packet comprises an uplink transmission packet or a sidelink transmission packet that UE 704 sends to node 702. Thus, after determining the available slot(s) to use for communicating repetition(s) of the transmission, at 718(1), UE 704 sends the transmission packet at 718(1). Further, UE 704 sends repetitions of the transmission packet at 718(2) through 718(X). Each repetition of the transmission packet may be sent in one of the available slots UE 704 determines to use for communicating a number of repetition(s) that satisfy the repetition factor, K. In certain aspects, UE 704 sends a repetition of the transmission packet in each of the determined available slot(s) such that a number of repetition(s) of the transmission packet satisfies the repetition factor, K. In certain other aspects, UE 704 sends a repetition of the transmission packet in less than all of the determined available slot(s). For example, UE 704 may determine to drop one or more of transmissions of the repeated transmission packet.

In certain aspects, the transmission packet comprises a downlink transmission packet or a sidelink transmission packet that UE 704 receives from node 702. Thus, after determining the available slot(s) to use for communicating repetition(s) of the transmission packet, at 718(1), UE 704 receives the transmission packet at 720(1). Further, UE 704 receives repetitions of the transmission packet at 720(2) through 720(Y). Each repetition of the transmission packet may be sent in one of the available slots UE 704 determines to use for communicating a number of repetition(s) that satisfy the repetition factor, K. In certain aspects, UE 704 receives a repetition of the transmission packet in each of the determined available slot(s) such that a number of repetition(s) of the transmission packet satisfies the repetition factor, K. In certain other aspects, UE 704 receives a repetition of the transmission packet in less than all of the determined available slot(s). For example, one or more transmissions of the repeated transmission packet may be dropped by node 702.

Note that the process flow 700 illustrated in FIG. 7 is described herein to facilitate an understanding of transmission repetition adaptation based on slot type, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

FIG. 8 depicts example transmission repetition determination as a function of the slot type(s) that may be used for carrying a transmission. As shown in FIG. 8, different schemes 802 and 804 for HD communications and/or FD communications, and more specifically, SBFD communications, may exist. For example, scheme 802 may include one HD slot for downlink communications (e.g., slot 812), two SBFD slots for uplink and downlink communications (e.g., slots 814 and 816), and one HD slot for uplink communications (e.g., slot 818). Further, scheme 804 may include one HD slot for downlink communications (e.g., slot 822), one SBFD slot for uplink and downlink communications (e.g., slot 826), and two HD slots for uplink communications (e.g., slots 824 and 828).

A number of slots to use for sending repetitions of an uplink transmission in scheme 802 may be different than a number of slots to use for sending repetitions of an the uplink transmission in scheme 804. For example, two slots in scheme 802 may be used for sending repetitions of the uplink transmission while only one slot in scheme 804 may be used for sending a repetition of the uplink transmission to achieve a same reliability for the uplink transmission.

For example, a repetition factor, K, for the uplink transmission may be equal to one (K=1). An SBFD duplexing factor, v_{SBFD}, may be equal to ½ (v_{SBFD}=½).

To satisfy the condition:

$${N}_{HD} \times 1 + {N}_{SBFD} \times {v}_{SBFD} \geq K$$

in scheme 802, a repetition of the uplink communication may need to be sent in slot 814 and slot 816 (and not send in slot 818). For example:

$${N}_{HD} \times 1 + {N}_{SBFD} \times {v}_{SBFD} \geq K$$

$$( 0 ) \times 1 + ( 2 SBFD slots ) \times ( 1 / 2 ) \geq 1$$

$$1 \geq 1$$

However, to satisfy the condition:

$${N}_{HD} \times 1 + {N}_{SBFD} \times {v}_{SBFD} \geq K$$

in scheme 804, a repetition of the uplink communication may need to be sent in only slot 824 (and not sent in slots 826 and 828). For example:

$${N}_{HD} \times 1 + {N}_{SBFD} \times {v}_{SBFD} \geq K$$

$$( 1 HD slot ) \times 1 + ( 0 ) \times ( 1 / 2 ) \geq 1$$

$$1 \geq 1$$

Note that the example schemes and repetition factor used in FIG. 8 are only examples, and other communication schemes (e.g., resources allocated per slot for HD, FD, and/or SBFD communications) and/or repetition factors may be used to determine a number of available slots to use for sending repetitions of a transmission based on slot type.

### Example Operations

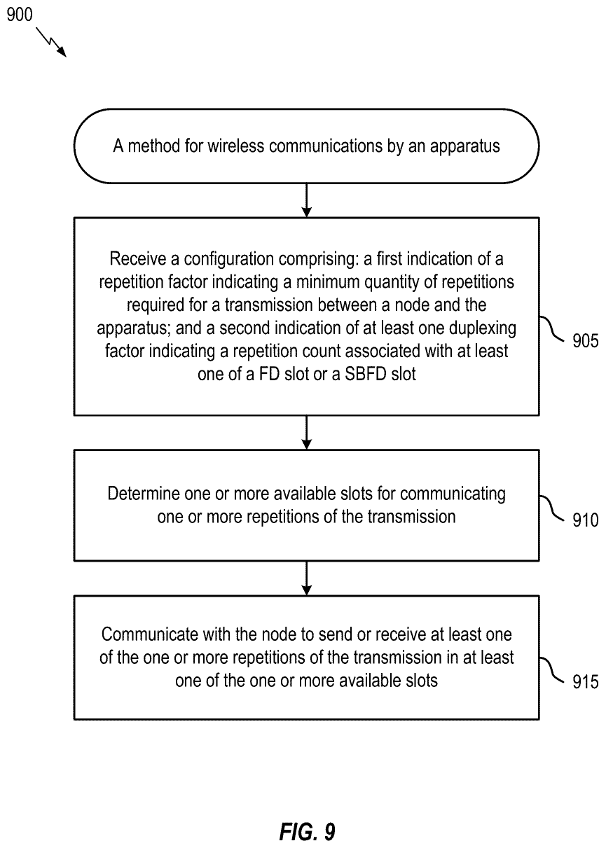

FIG. 9 shows a method 900 for wireless communications by an apparatus, such as UE 104 of FIGS. 1 and 3.

Method 900 begins at block 905 with receiving a configuration comprising: a first indication of a repetition factor indicating a minimum quantity of repetitions required for a transmission between a node and the apparatus; and a second indication of at least one duplexing factor indicating a repetition count associated with at least one of a FD slot or a SBFD slot.

Method 900 then proceeds to block 910 with determining one or more available slots for communicating one or more repetitions of the transmission. The one or more available slots may comprise at least one of the FD slot or the SBFD slot. Further, a number of the one or more available slots may satisfy the repetition factor when using the at least one duplexing factor to count at least one of the repetitions of the transmission in at least one of the FD slot or the SBFD slot.

Method 900 then proceeds to block 915 with communicating with the node to send or receive at least one of the one or more repetitions of the transmission in at least one of the one or more available slots.

In one aspect, block 915 includes communicating the one or more repetitions of the transmission in the one or more available slots such that the one or more repetitions of the transmission satisfy the repetition factor when using the at least one duplexing factor to count at least one of the one or more repetitions of the transmission in at least one of the FD slot or the SBFD slot.

In one aspect, block 910 includes determining the one or more available slots based at least in part on: the repetition factor, the at least one duplexing factor, and a slot type of each of the one or more available slots, wherein the slot type comprises a HD slot, the FD slot, or the SBFD slot.

In one aspect, the at least one duplexing factor comprises a duplexing factor indicating the repetition count associated with the FD slot and the SBFD slot.

In one aspect, the at least one duplexing factor comprises: a SBFD duplexing factor indicating an SBFD slot repetition count associated with the SBFD slot; and an FD duplexing factor indicating an FD slot repetition count associated with the SBFD slot, and block 910 includes determining the one or more available slots based on the SBFD duplexing factor and the FD duplexing factor.

In one aspect, the at least one duplexing factor comprises: a SBFD duplexing factor indicating an SBFD slot repetition count associated with the SBFD slot; and an FD duplexing factor indicating an FD slot repetition count associated with the SBFD slot, and block 910 includes determining the one or more available slots based at least in part on a summation that satisfies the repetition factor, wherein the summation comprises a sum of: a first number of HD slots included in the one or more available slots multiplied by one; a second number of SBFD slots included in the one or more available slots multiplied by the SBFD duplexing factor; and a third number of FD slots included in the one or more available slots multiplied by the FD duplexing factor.

In one aspect, the SBFD duplexing factor and the FD duplexing factor are different.

In one aspect, the second indication of the at least one duplexing factor comprises an indication of an index associated with the at least one duplexing factor.

In one aspect, the configuration comprises a dynamic configuration or a semi-static configuration.

In one aspect, the configuration comprises a broadcast transmission or a multicast transmission scheduled for a group of user equipments, including the apparatus.

In one aspect, the at least one duplexing factor is channel-specific.

In one aspect, block 905 includes receiving the configuration via: radio resource control signaling; a medium access control control element; a downlink control information; a master information block; a system information block; sidelink radio resource control signaling; sidelink control information 1; or sidelink control information 2.

In one aspect, the transmission comprises a sidelink transmission.

In one aspect, method 900 further includes receiving a configuration of a plurality of available slots comprising at least the one or more available slots.

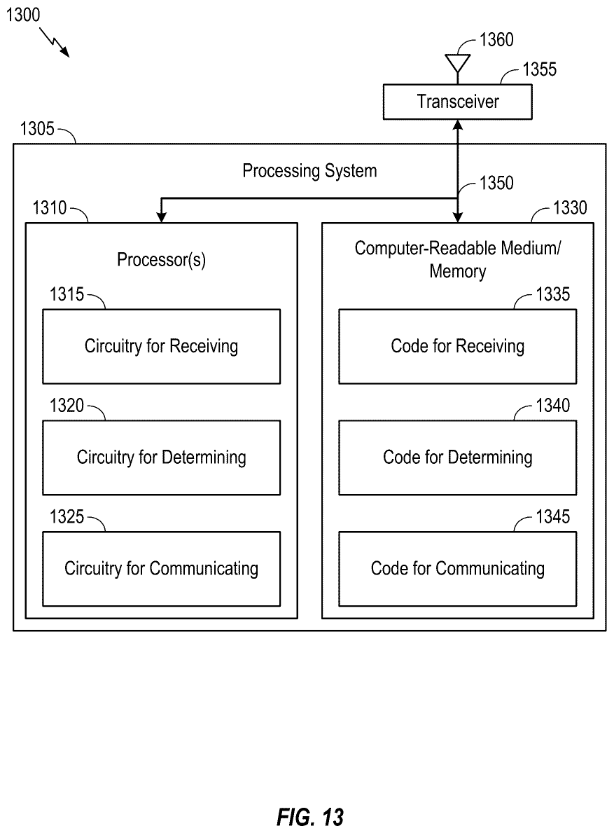

In one aspect, method 900, or any aspect related to it, may be performed by an apparatus, such as communications device 1300 of FIG. 13, which includes various components operable, configured, or adapted to perform the method 900. Communications device 1300 is described below in further detail.

Method 900 provides the beneficial technical effect of improved wireless communication reliability when repetitions of a transmission packet are to be sent in FD and/or SBFD slots. For example, from a repetition counting perspective, instead of setting the duplexing factor (e.g., repetition count) for HD, FD and/or SBFD slots as a same value (e.g., legacy design), a different duplexing factor for FD and/or SBFD slots may be used. The duplexing factor for FD and/or SBFD slots may be less than a duplexing factor used for HD slots such that repetitions of a transmission packet that are to be sent in FD and/or SBFD slots naturally force the apparatus to determine that more repetitions of the transmission packet (e.g., in more slots) are needed to achieve a repetition for the transmission packet greater than a repetition factor, K. Achieving a repetition for the transmission packet greater than the repetition factor, K, may help to ensure that certain level of reliability (e.g., associated with the repetition factor, K) is obtained for the transmission packet.

Note that FIG. 9 is just one example of a method, and other methods including fewer, additional, or alternative operations are possible consistent with this disclosure.

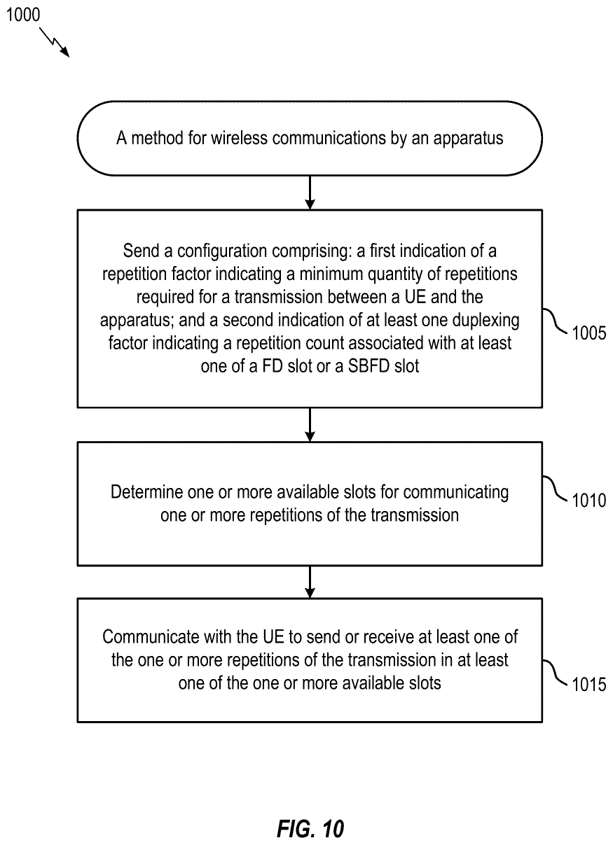

FIG. 10 shows a method 1000 of wireless communications by an apparatus, such as UE 104 of FIGS. 1 and 3, BS 102 of FIGS. 1 and 3, or a disaggregated base station discussed with respect to FIG. 2.

Method 1000 begins at block 1005 with sending a configuration comprising: a first indication of a repetition factor indicating a minimum quantity of repetitions required for a transmission between a UE and the apparatus; and a second indication of at least one duplexing factor indicating a repetition count associated with at least one of a FD slot or a SBFD slot.

Method 1000 then proceeds to block 1010 with determining one or more available slots for communicating one or more repetitions of the transmission. The one or more available slots may comprise at least one of the FD slot or the SBFD slot. Further, a number of the one or more available slots may satisfy the repetition factor when using the at least one duplexing factor to count at least one of the repetitions of the transmission in at least one of the FD slot or the SBFD slot.

Method 1000 then proceeds to block 1015 with communicating with the UE to send or receive at least one of the one or more repetitions of the transmission in at least one of the one or more available slots.

In one aspect, block 1015 includes communicating the one or more repetitions of the transmission in the one or more available slots such that the one or more repetitions of the transmission satisfy the repetition factor when using the at least one duplexing factor to count at least one of the one or more repetitions of the transmission in at least one of the FD slot or the SBFD slot.

In one aspect, block 1010 includes determining the one or more available slots based at least in part on: the repetition factor, the at least one duplexing factor, and a slot type of each of the one or more available slots, wherein the slot type comprises a HD slot, the FD slot, or the SBFD slot.

In one aspect, the at least one duplexing factor comprises a duplexing factor indicating the repetition count associated with the FD slot and the SBFD slot.

In one aspect, the at least one duplexing factor comprises: a SBFD duplexing factor indicating an SBFD slot repetition count associated with the SBFD slot; and an FD duplexing factor indicating an FD slot repetition count associated with the SBFD slot, and block 1010 includes determining the one or more available slots based on the SBFD duplexing factor and the FD duplexing factor.

In one aspect, the at least one duplexing factor comprises: a SBFD duplexing factor indicating an SBFD slot repetition count associated with the SBFD slot; and an FD duplexing factor indicating an FD slot repetition count associated with the SBFD slot, and block 1010 includes determining the one or more available slots based at least in part on a summation that satisfies the repetition factor, wherein the summation comprises a sum of: a first number of HD slots included in the one or more available slots multiplied by one; a second number of SBFD slots included in the one or more available slots multiplied by the SBFD duplexing factor; and a third number of FD slots included in the one or more available slots multiplied by the FD duplexing factor.

In one aspect, the SBFD duplexing factor and the FD duplexing factor are different.

In one aspect, the second indication of the at least one duplexing factor comprises an indication of an index associated with the at least one duplexing factor.

In one aspect, the configuration comprises a dynamic configuration or a semi-static configuration.

In one aspect, the configuration comprises a broadcast transmission or a multicast transmission scheduled for a group of UEs, including the UE.

In one aspect, the at least one duplexing factor is channel-specific.

In one aspect, block 1005 includes sending the configuration via: radio resource control signaling; a medium access control control element; a downlink control information; a master information block; a system information block; sidelink radio resource control signaling; sidelink control information 1; or sidelink control information 2.

In one aspect, the transmission comprises a sidelink transmission.

In one aspect, method 1000 further includes sending a configuration of a plurality of available slots comprising at least the one or more available slots.

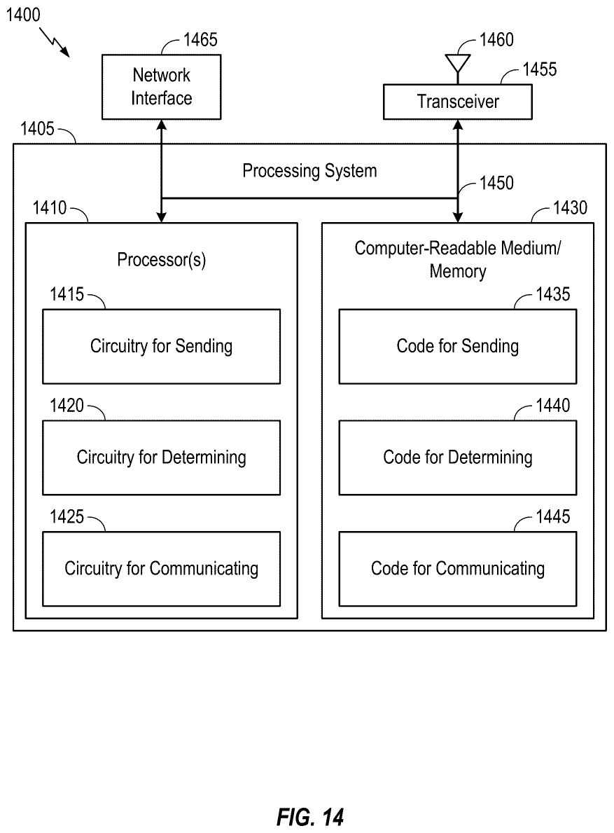

In one aspect, method 1000, or any aspect related to it, may be performed by an apparatus, such as communications device 1400 of FIG. 14, which includes various components operable, configured, or adapted to perform the method 1000. Communications device 1400 is described below in further detail.

Method 1000 provides the beneficial technical effect of improved wireless communication reliability when repetitions of a transmission packet are sent in FD and/or SBFD slots.

Note that FIG. 10 is just one example of a method, and other methods including fewer, additional, or alternative operations are possible consistent with this disclosure.

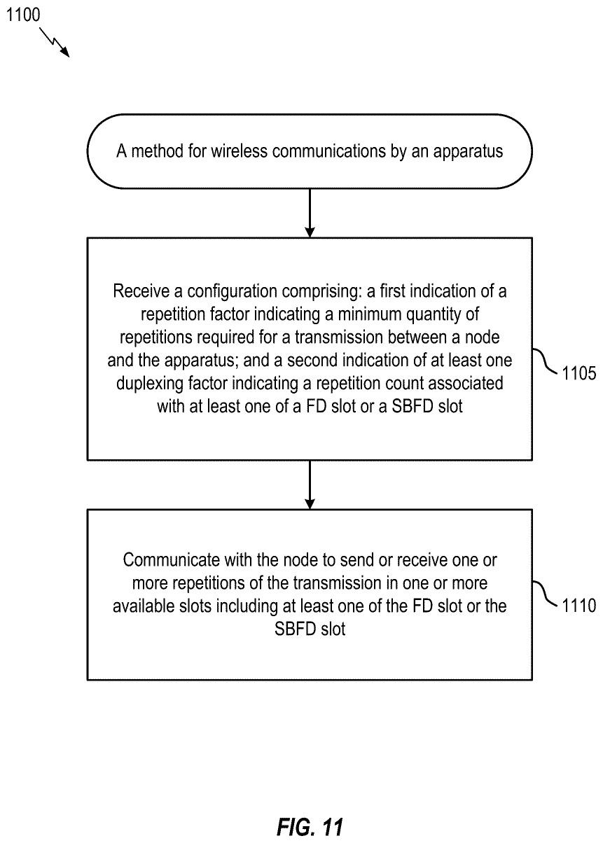

FIG. 11 shows a method 1100 for wireless communications by an apparatus, such as UE 104 of FIGS. 1 and 3.

Method 1100 begins at block 1105 with receiving a configuration comprising: a first indication of a repetition factor indicating a minimum quantity of repetitions required for a transmission between a node and the apparatus; and a second indication of at least one duplexing factor indicating a repetition count associated with at least one of a FD slot or a SBFD slot.

Method 1100 then proceeds to block 1110 with communicating with the node to send or receive one or more repetitions of the transmission in one or more available slots including at least one of the FD slot or the SBFD slot. In certain aspects, the one or more repetitions of the transmission satisfy the repetition factor when using the at least one duplexing factor to count at least one of the one or more repetitions of the transmission in the at least one of the FD slot or the SBFD slot.

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Method 1100 provides the beneficial technical effect of improved wireless communication reliability when repetitions of a transmission packet are sent in FD and/or SBFD slots. For example, from a repetition counting perspective, instead of setting the duplexing factor (e.g., repetition count) for HD, FD and/or SBFD slots as a same value (e.g., legacy design), a different duplexing factor for FD and/or SBFD slots may be used. The duplexing factor for FD and/or SBFD slots may be less than a duplexing factor used for HD slots such that repetitions of a transmission packet sent in FD and/or SBFD slots naturally force the apparatus to send more repetitions of the transmission packet (e.g., in more slots) to achieve a repetition for the transmission packet greater than a repetition factor, K. Achieving a repetition for the transmission packet greater than the repetition factor, K, may help to ensure that certain level of reliability (e.g., associated with the repetition factor, K) is obtained for the transmission packet.

Note that FIG. 11 is just one example of a method, and other methods including fewer, additional, or alternative operations are possible consistent with this disclosure.

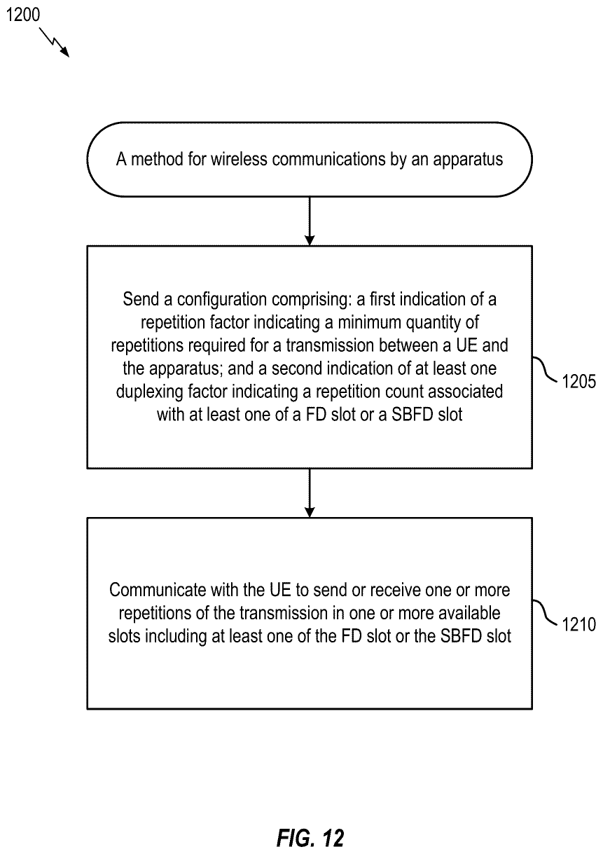

FIG. 12 shows a method 1200 of wireless communications by an apparatus, such as UE 104 of FIGS. 1 and 3, BS 102 of FIGS. 1 and 3, or a disaggregated base station discussed with respect to FIG. 2.

Method 1200 begins at block 1205 with sending a configuration comprising: a first indication of a repetition factor indicating a minimum quantity of repetitions required for a transmission between a UE and the apparatus; and a second indication of at least one duplexing factor indicating a repetition count associated with at least one of a FD slot or a SBFD slot.

Method 1200 then proceeds to block 1210 with communicating with the UE to send or receive one or more repetitions of the transmission in one or more available slots including at least one of the FD slot or the SBFD slot. In certain aspects, the one or more repetitions of the transmission satisfy the repetition factor when using the at least one duplexing factor to count at least one of the one or more repetitions of the transmission in the at least one of the FD slot or the SBFD slot.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Method 1200 provides the beneficial technical effect of improved wireless communication reliability when repetitions of a transmission packet are sent in FD and/or SBFD slots.

Note that FIG. 12 is just one example of a method, and other methods including fewer, additional, or alternative operations are possible consistent with this disclosure.

### Example Communications Devices

FIG. 13 depicts aspects of an example communications device 1300. In some aspects, communications device 1300 is a user equipment, such as UE 104 described above with respect to FIGS. 1 and 3.

The communications device 1300 includes a processing system 1305 coupled to a transceiver 1355 (e.g., a transmitter and/or a receiver). The transceiver 1355 is configured to transmit and receive signals for the communications device 1300 via an antenna 1360, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1330 via a bus 1350. In certain aspects, the computer-readable medium/memory 1330 is configured to store instructions (e.g., computer-executable code), including code 1335-1345, that when executed by the one or more processors 1310, enable and cause the one or more processors 1310 to perform: the method 900 described with respect to FIG. 9, or any aspect related to it, including any operations described in relation to FIG. 9; and/or the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1330 stores code for receiving 1335, code for determining 1340, and code for communicating 1345. Processing of the code 1335-1345 may enable and cause the communications device 1300 to perform: the method 900 described with respect to FIG. 9, or any aspect related to it; and/or the method 1100 described with respect to FIG. 11, or any aspect related to it.

The one or more processors 1310 include circuitry configured to implement (e.g., execute) the code (e.g., executable instructions) stored in the computer-readable medium/memory 1330, including circuitry for receiving 1315, circuitry for determining 1320, and circuitry for communicating 1325. Processing with circuitry 1315-1325 may enable and cause the communications device 1300 to perform: the method 900 described with respect to FIG. 9, or any aspect related to it; and/or the method 1100 described with respect to FIG. 11, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1355 and/or antenna 1360 of the communications device 1300 in FIG. 13, and/or one or more processors 1310 of the communications device 1300 in FIG. 13. Means for communicating, receiving or obtaining may include the transceivers 354, antenna(s) 352, receive processor 358, AI processor 370, and/or controller/processor 380 of the UE 104 illustrated in FIG. 3, transceiver 1355 and/or antenna 1360 of the communications device 1300 in FIG. 13, and/or one or more processors 1310 of the communications device 1300 in FIG. 13.

FIG. 14 depicts aspects of an example communications device 1400. In some aspects, communications device 1400 is a user equipment, such as UE 104 described above with respect to FIGS. 1 and 3. In some aspects, communications device 1400 is a network entity, such as BS 102 of FIGS. 1 and 3, or a disaggregated base station as discussed with respect to FIG. 2.

The communications device 1400 includes a processing system 1405 coupled to a transceiver 1455 (e.g., a transmitter and/or a receiver) and/or a network interface 1465. The transceiver 1455 is configured to transmit and receive signals for the communications device 1400 via an antenna 1460, such as the various signals as described herein. The network interface 1465 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 338, receive processor 358, transmit processor 320, transmit processor 364, TX MIMO processor 330, TX MIMO processor 366, controller/processor 340, and/or controller/processor 380, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code), including code 1435-1445, that when executed by the one or more processors 1410, enable and cause the one or more processors 1410 to perform: the method 1000 described with respect to FIG. 10, or any aspect related to it, including any operations described in relation to FIG. 10; and/or the method 1200 described with respect to FIG. 12, or any aspect related to it, including any operations described in relation to FIG. 12. Note that reference to a processor performing a function of communications device 1400 may include one or more processors performing that function of communications device 1400, such as in a distributed fashion.

In the depicted example, computer-readable medium/memory 1430 stores code for sending 1435, code for determining 1440, and code for communicating 1445. Processing of the code 1435-1445 may enable and cause the communications device 1400 to perform: the method 1000 described with respect to FIG. 10, or any aspect related to it; and/or the method 1200 described with respect to FIG. 12, or any aspect related to it.

The one or more processors 1410 include circuitry configured to implement (e.g., execute) the code (e.g., executable instructions) stored in the computer-readable medium/memory 1430, including circuitry for sending 1415, circuitry for determining 1420, and circuitry for communicating 1425. Processing with circuitry 1415-1425 may enable and cause the communications device 1400 to perform: the method 1000 described with respect to FIG. 10, or any aspect related to it; and/or the method 1200 described with respect to FIG. 12, or any aspect related to it.

Various components of the communications device 1400 may provide means for performing the method 1000 described with respect to FIG. 10, or any aspect related to it; and the method 1200 described with respect to FIG. 12, or any aspect related to it. Means for communicating, transmitting, sending or outputting for transmission may include: the transceivers 332, antenna(s) 334, transmit processor 320, TX MIMO processor 330, AI processor 318, and/or controller/processor 340 of the BS 102 illustrated in FIG. 3; the transceivers 354, antenna(s) 352, transmit processor 364, TX MIMO processor 366, AI processor 370, and/or controller/processor 380 of the UE 104 illustrated in FIG. 3; transceiver 1455, antenna 1460, and/or network interface 1465 of the communications device 1400 in FIG. 14; and/or one or more processors 1410 of the communications device 1400 in FIG. 14. Means for communicating, receiving or obtaining may include: the transceivers 332, antenna(s) 334, receive processor 338, AI processor 318, and/or controller/processor 340 of the BS 102 illustrated in FIG. 3; the transceivers 354, antenna(s) 352, receive processor 358, AI processor 370, and/or controller/processor 380 of the UE 104 illustrated in FIG. 3; transceiver 1455, antenna 1460, and/or network interface 1465 of the communications device 1400 in FIG. 14; and/or one or more processors 1404 of the communications device 1400 in FIG. 14.

### Example Clauses

Implementation examples are described in the following numbered clauses:

Clause 1: A method for wireless communications by an apparatus comprising: receiving a configuration comprising: a first indication of a repetition factor indicating a minimum quantity of repetitions required for a transmission between a node and the apparatus; and a second indication of at least one duplexing factor indicating a repetition count associated with at least one of a FD slot or a SBFD slot; determining one or more available slots for communicating one or more repetitions of the transmission, wherein: the one or more available slots comprise at least one of the FD slot or the SBFD slot; and a number of the one or more available slots satisfy the repetition factor when using the at least one duplexing factor to count at least one of the one or more repetitions of the transmission in at least one of the FD slot or the SBFD slot; and communicating with the node to send or receive at least one of the one or more repetitions of the transmission in at least one of the one or more available slots.

Clause 2: The method of Clause 1, wherein communicating at least one of the one or more repetitions of the transmission comprises communicating the one or more repetitions of the transmission in the one or more available slots such that the one or more repetitions of the transmission satisfy the repetition factor when using the at least one duplexing factor to count at least one of the one or more repetitions of the transmission in at least one of the FD slot or the SBFD slot.

Clause 3: The method of any one of Clauses 1-2, wherein determining the one or more available slots comprises determining the one or more available slots based at least in part on: the repetition factor, the at least one duplexing factor, and a slot type of each of the one or more available slots, wherein the slot type comprises a HD slot, the FD slot, or the SBFD slot.

Clause 4: The method of Clause 3, wherein the at least one duplexing factor comprises a duplexing factor indicating the repetition count associated with the FD slot and the SBFD slot.

Clause 5: The method of Clause 3, wherein: the at least one duplexing factor comprises: a SBFD duplexing factor indicating an SBFD slot repetition count associated with the SBFD slot; and an FD duplexing factor indicating an FD slot repetition count associated with the SBFD slot, and determining the one or more available slots comprises determining the one or more available slots based on the SBFD duplexing factor and the FD duplexing factor.

Clause 6: The method of any one of Clauses 1-5, wherein: the at least one duplexing factor comprises: a SBFD duplexing factor indicating an SBFD slot repetition count associated with the SBFD slot; and an FD duplexing factor indicating an FD slot repetition count associated with the SBFD slot, and determining the one or more available slots comprises determining the one or more available slots based at least in part on a summation that satisfies the repetition factor, wherein the summation comprises a sum of: a first number of HD slots included in the one or more available slots multiplied by one; a second number of SBFD slots included in the one or more available slots multiplied by the SBFD duplexing factor; and a third number of FD slots included in the one or more available slots multiplied by the FD duplexing factor.

Clause 7: The method of Clause 6, wherein the SBFD duplexing factor and the FD duplexing factor are different.

Clause 8: The method of any one of Clauses 1-7, wherein the second indication of the at least one duplexing factor comprises an indication of an index associated with the at least one duplexing factor.

Clause 9: The method of any one of Clauses 1-8, wherein the configuration comprises a dynamic configuration or a semi-static configuration.

Clause 10: The method of any one of Clauses 1-9, wherein the configuration comprises a broadcast transmission or a multicast transmission scheduled for a group of user equipments, including the apparatus.

Clause 11: The method of any one of Clauses 1-10, wherein the at least one duplexing factor is channel-specific.

Clause 12: The method of any one of Clauses 1-11, wherein receiving the configuration comprises receiving the configuration via: radio resource control signaling; a medium access control control element; a downlink control information; a master information block; a system information block; sidelink radio resource control signaling; sidelink control information 1; or sidelink control information 2.

Clause 13: The method of any one of Clauses 1-12, wherein the transmission comprises a sidelink transmission.

Clause 14: The method of any one of Clauses 1-13, further comprising receiving a configuration of a plurality of available slots comprising at least the one or more available slots.

Clause 15: A method for wireless communications by an apparatus comprising: sending a configuration comprising: a first indication of a repetition factor indicating a minimum quantity of repetitions required for a transmission between a UE and the apparatus; and a second indication of at least one duplexing factor indicating a repetition count associated with at least one of a FD slot or a SBFD slot; determining one or more available slots for communicating one or more repetitions of the transmission, wherein: the one or more available slots comprise at least one of the FD slot or the SBFD slot, and a number of the one or more available slots satisfy the repetition factor when using the at least one duplexing factor to count at least one of the repetitions of the transmission in at least one of the FD slot or the SBFD slot; and communicating with the UE to send or receive at least one of the one or more repetitions of the transmission in at least one of the one or more available slots.

Clause 16: The method of Clause 15, wherein communicating at least one of the one or more repetitions of the transmission comprises communicating the one or more repetitions of the transmission in the one or more available slots such that the one or more repetitions of the transmission satisfy the repetition factor when using the at least one duplexing factor to count at least one of the one or more repetitions of the transmission in at least one of the FD slot or the SBFD slot.

Clause 17: The method of any one of Clauses 15-16, wherein determining the one or more available slots comprises determining the one or more available slots based at least in part on: the repetition factor, the at least one duplexing factor, and a slot type of each of the one or more available slots, wherein the slot type comprises a HD slot, the FD slot, or the SBFD slot.

Clause 18: The method of Clause 17, wherein the at least one duplexing factor comprises a duplexing factor indicating the repetition count associated with the FD slot and the SBFD slot.

Clause 19: The method of Clause 17, wherein: the at least one duplexing factor comprises: a SBFD duplexing factor indicating an SBFD slot repetition count associated with the SBFD slot; and an FD duplexing factor indicating an FD slot repetition count associated with the SBFD slot, and determining the one or more available slots comprises determining the one or more available slots based on the SBFD duplexing factor and the FD duplexing factor.

Clause 20: The method of any one of Clauses 15-19, wherein: the at least one duplexing factor comprises: a SBFD duplexing factor indicating an SBFD slot repetition count associated with the SBFD slot; and an FD duplexing factor indicating an FD slot repetition count associated with the SBFD slot, and determining the one or more available slots comprises determining the one or more available slots based at least in part on a summation that satisfies the repetition factor, wherein the summation comprises a sum of: a first number of HD slots included in the one or more available slots multiplied by one; a second number of SBFD slots included in the one or more available slots multiplied by the SBFD duplexing factor; and a third number of FD slots included in the one or more available slots multiplied by the FD duplexing factor.

Clause 21: The method of Clause 20, wherein the SBFD duplexing factor and the FD duplexing factor are different.

Clause 22: The method of any one of Clauses 15-21, wherein the second indication of the at least one duplexing factor comprises an indication of an index associated with the at least one duplexing factor.

Clause 23: The method of any one of Clauses 15-22, wherein the configuration comprises a dynamic configuration or a semi-static configuration.

Clause 24: The method of any one of Clauses 15-23, wherein the configuration comprises a broadcast transmission or a multicast transmission scheduled for a group of UEs, including the UE.

Clause 25: The method of any one of Clauses 15-24, wherein the at least one duplexing factor is channel-specific.

Clause 26: The method of any one of Clauses 15-25, wherein sending the configuration comprises sending the configuration via: radio resource control signaling; a medium access control control element; a downlink control information; a master information block; a system information block; sidelink radio resource control signaling; sidelink control information 1; or sidelink control information 2.

Clause 27: The method of any one of Clauses 15-26, wherein the transmission comprises a sidelink transmission.

Clause 28: The method of any one of Clauses 15-27, further comprising sending a configuration of a plurality of available slots comprising at least the one or more available slots.

Clause 29: A method for wireless communications by an apparatus comprising: receiving a configuration comprising: a first indication of a repetition factor indicating a minimum quantity of repetitions required for a transmission between a node and the apparatus; and a second indication of at least one duplexing factor indicating a repetition count associated with at least one of a FD slot or a SBFD slot; and communicating with the node to send or receive one or more repetitions of the transmission in one or more available slots including at least one of the FD slot or the SBFD slot, wherein the one or more repetitions of the transmission satisfy the repetition factor when using the at least one duplexing factor to count at least one of the one or more repetitions of the transmission in the at least one of the FD slot or the SBFD slot.

Clause 30: A method for wireless communications by an apparatus comprising: sending a configuration comprising: a first indication of a repetition factor indicating a minimum quantity of repetitions required for a transmission between a UE and the apparatus; and a second indication of at least one duplexing factor indicating a repetition count associated with at least one of a FD slot or a SBFD slot; and communicating with the UE to send or receive one or more repetitions of the transmission in one or more available slots including at least one of the FD slot or the SBFD slot, wherein the one or more repetitions of the transmission satisfy the repetition factor when using the at least one duplexing factor to count at least one of the one or more repetitions of the transmission in the at least one of the FD slot or the SBFD slot.

Clause 31: One or more apparatuses, comprising: one or more memories comprising executable instructions; and one or more processors configured to execute the executable instructions and cause the one or more apparatuses to perform a method in accordance with any one of Clauses 1-30.

Clause 32: One or more apparatuses, comprising: one or more memories; and one or more processors, coupled to the one or more memories, configured to cause the one or more apparatuses to perform a method in accordance with any one of Clauses 1-30.

Clause 33: One or more apparatuses, comprising: one or more memories; and one or more processors, coupled to the one or more memories, configured to perform a method in accordance with any one of Clauses 1-30.

Clause 34: One or more apparatuses, comprising means for performing a method in accordance with any one of Clauses 1-30.

Clause 35: One or more non-transitory computer-readable media comprising executable instructions that, when executed by one or more processors of one or more apparatuses, cause the one or more apparatuses to perform a method in accordance with any one of Clauses 1-30.

Clause 36: One or more computer program products embodied on one or more computer-readable storage media comprising code for performing a method in accordance with any one of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors, coupled to the one or more memories, configured to cause the apparatus to:
receive a configuration comprising:
a first indication of a repetition factor indicating a minimum quantity of repetitions required for a transmission between a node and the apparatus; and
a second indication of at least one duplexing factor indicating a repetition count associated with at least one of a full duplex (FD) slot or a sub-band full duplex (SBFD) slot;
determine one or more available slots for communicating one or more repetitions of the transmission, wherein:
the one or more available slots comprise at least one of the FD slot or the SBFD slot, and
a number of the one or more available slots satisfy the repetition factor when using the at least one duplexing factor to count at least one of the one or more repetitions of the transmission in at least one of the FD slot or the SBFD slot; and
communicate with the node to send or receive at least one of the one or more repetitions of the transmission in at least one of the one or more available slots.

2. The apparatus of claim 1, wherein to communicate at least one of the one or more repetitions of the transmission, the one or more processors are configured to cause the apparatus to communicate the one or more repetitions of the transmission in the one or more available slots such that the one or more repetitions of the transmission satisfy the repetition factor when using the at least one duplexing factor to count at least one of the one or more repetitions of the transmission in at least one of the FD slot or the SBFD slot.

3. The apparatus of claim 1, wherein to determine the one or more available slots, the one or more processors are configured to cause the apparatus to determine the one or more available slots based at least in part on:
the repetition factor,
the at least one duplexing factor, and
a slot type of each of the one or more available slots, wherein the slot type comprises a half-duplex (HD) slot, the FD slot, or the SBFD slot.

4. The apparatus of claim 3, wherein the at least one duplexing factor comprises a duplexing factor indicating the repetition count associated with the FD slot and the SBFD slot.

5. The apparatus of claim 3, wherein:
the at least one duplexing factor comprises:
a SBFD duplexing factor indicating an SBFD slot repetition count associated with the SBFD slot; and
an FD duplexing factor indicating an FD slot repetition count associated with the SBFD slot, and
to determine the one or more available slots, the one or more processors are configured to cause the apparatus to determine the one or more available slots based on the SBFD duplexing factor and the FD duplexing factor.

6. The apparatus of claim 1, wherein:
the at least one duplexing factor comprises:
a SBFD duplexing factor indicating an SBFD slot repetition count associated with the SBFD slot; and
an FD duplexing factor indicating an FD slot repetition count associated with the SBFD slot, and
to determine the one or more available slots, the one or more processors are configured to cause the apparatus to determine the one or more available slots based at least in part on a summation that satisfies the repetition factor, wherein the summation comprises a sum of:
a first number of half-duplex (HD) slots included in the one or more available slots multiplied by one;
a second number of SBFD slots included in the one or more available slots multiplied by the SBFD duplexing factor; and
a third number of FD slots included in the one or more available slots multiplied by the FD duplexing factor.

7. The apparatus of claim 6, wherein the SBFD duplexing factor and the FD duplexing factor are different.

8. The apparatus of claim 1, wherein the second indication of the at least one duplexing factor comprises an indication of an index associated with the at least one duplexing factor.

9. The apparatus of claim 1, wherein the configuration comprises a dynamic configuration or a semi-static configuration.

10. The apparatus of claim 1, wherein the configuration comprises a broadcast transmission or a multicast transmission scheduled for a group of user equipments, including the apparatus.

11. The apparatus of claim 1, wherein the at least one duplexing factor is channel-specific.

12. The apparatus of claim 1, wherein the transmission comprises a sidelink transmission.

13. A method for wireless communications by an apparatus, comprising:
receiving a configuration comprising:
a first indication of a repetition factor indicating a minimum quantity of repetitions required for a transmission between a node and the apparatus; and
a second indication of at least one duplexing factor indicating a repetition count associated with at least one of a full duplex (FD) slot or a sub-band full duplex (SBFD) slot;
determining one or more available slots for communicating one or more repetitions of the transmission, wherein:
the one or more available slots comprise at least one of the FD slot or the SBFD slot, and
a number of the one or more available slots satisfy the repetition factor when using the at least one duplexing factor to count at least one of the one or more repetitions of the transmission in at least one of the FD slot or the SBFD slot; and
communicating with the node to send or receive at least one of the one or more repetitions of the transmission in at least one of the one or more available slots.

14. The method of claim 13, wherein communicating at least one of the one or more repetitions of the transmission comprises communicating the one or more repetitions of the transmission in the one or more available slots such that the one or more repetitions of the transmission satisfy the repetition factor when using the at least one duplexing factor to count at least one of the one or more repetitions of the transmission in at least one of the FD slot or the SBFD slot.

15. The method of claim 13, wherein determining the one or more available slots comprises determining the one or more available slots based at least in part on:
the repetition factor,
the at least one duplexing factor, and
a slot type of each of the one or more available slots, wherein the slot type comprises a half-duplex (HD) slot, the FD slot, or the SBFD slot.

16. The method of claim 15, wherein the at least one duplexing factor comprises a duplexing factor indicating the repetition count associated with the FD slot and the SBFD slot.

17. The method of claim 16, wherein:
the at least one duplexing factor comprises:
a SBFD duplexing factor indicating an SBFD slot repetition count associated with the SBFD slot; and
an FD duplexing factor indicating an FD slot repetition count associated with the SBFD slot, and
determining the one or more available slots comprises determining the one or more available slots based on the SBFD duplexing factor and the FD duplexing factor.

18. The method of claim 13, wherein:
the at least one duplexing factor comprises:
a SBFD duplexing factor indicating an SBFD slot repetition count associated with the SBFD slot; and
an FD duplexing factor indicating an FD slot repetition count associated with the SBFD slot, and
determining the one or more available slots comprises determining the one or more available slots based at least in part on a summation that satisfies the repetition factor, wherein the summation comprises a sum of:
a first number of half-duplex (HD) slots included in the one or more available slots multiplied by one;
a second number of SBFD slots included in the one or more available slots multiplied by the SBFD duplexing factor; and
a third number of FD slots included in the one or more available slots multiplied by the FD duplexing factor.

19. The method of claim 18, wherein the SBFD duplexing factor and the FD duplexing factor are different.

20. An apparatus configured for wireless communications, comprising:
one or more memories; and
one or more processors, coupled to the one or more memories, configured to cause the apparatus to:
receive a configuration comprising:
a first indication of a repetition factor indicating a minimum quantity of repetitions required for a transmission between a node and the apparatus; and
a second indication of at least one duplexing factor indicating a repetition count associated with at least one of a full duplex (FD) slot or a sub-band full duplex (SBFD) slot; and
communicate with the node to send or receive one or more repetitions of the transmission in one or more available slots including at least one of the FD slot or the SBPD slot, wherein the one or more repetitions of the transmission satisfy the repetition factor when using the at least one duplexing factor to count at least one of the one or more repetitions of the transmission in the at least one of the FD slot or the SBFD slot.
